(19) United States
(12) Patent Application Publication
(10) Pub. No.: US 2026/0267817 A1
(43) Pub. Date: Sep. 10, 2026

(54) METHOD FOR DETERMINING A BUS SUBSCRIBER ARRANGEMENT IN AN AUTOMATION NETWORK AND AUTOMATION NETWORK

(71) Applicant: Beckhoff Automation GmbH, Verl (DE)

(72) Inventors: Holger Büttner, Berlin (DE); Dirk Janssen, Verl (DE); Richard Kümmel, Bielefeld (DE); Guido Beckmann, Verl (DE); Thomas Rettig, Rheda-Wiedenbrück (DE)

(21) Appl. No.: 19/672,835

(22) Filed: May 11, 2026

Related U.S. Application Data
(63) Continuation of application No. PCT/EP2024/081494, filed on Nov. 7, 2024.

(30) Foreign Application Priority Data
Nov. 13, 2023 (DE) 10 2023 131 495.5

(51) Int. Cl. G06F 13/42

(52) U.S. Cl. CPC G06F 13/42; G06F 2213/40

(57) ABSTRACT

To determine a bus subscriber arrangement in an automation network, the following steps are carried out: outputting a data packet via a control bus subscriber on a data line, where each bus subscriber records a forward timestamp upon receiving the data packet through an input/output port on the forward path and a return timestamp upon receiving the data packet through another input/output port on the return path; correlating the recorded timestamps of each bus subscriber by forming a differential amount between the forward and return timestamps, where for the last bus subscriber, for which only a first timestamp is recorded, the second timestamp is set equal to the first timestamp; and sorting the differences from the largest to the smallest value in order to determine the set-up sequence of the bus subscribers, starting from the control bus subscriber as a set-up line of the bus subscribers.

### CROSS REFERENCE TO RELATED APPLICATIONS

This patent application is a continuation of International Patent Application No. PCT/EP2024/081494, filed Nov. 7, 2024, “Method for Determining a Bus Subscriber Arrangement in an Automation Network, and Automation Network,” which claims the priority of German patent application DE 10 2023 131 495.5, filed Nov. 13, 2023, “Verfahren zum Ermitteln einer Aufbaureihenfolge von Bus-teilnehmern eines Automatisierungsnetzwerks, Verfahren zur Steuerung einer Mehrzahl an Busteilnehmern eines Automati-sierungsnetzwerks, Busteilnehmer und Automatisierungsnetzwerk,” each of which is incorporated by reference herein, in the entirety and for all purposes.

### FIELD

The invention relates to a method for determining a bus subscriber arrangement in an automation network.

### BACKGROUND

Fieldbus systems, the message transmission of which is based on the Ethernet protocol, are frequently operated in the form of a control bus subscriber, i.e., a central controller or a main device, and a subordinate bus subscriber or, respectively, a subordinate unit in a system or machine, which is controlled by the control bus subscriber. The control bus subscriber is the central controller that has bus access authorization and may output data to the field bus. The subordinate bus subscribers or subordinate units in the field-bus system are the field devices, such as I/O devices, drives, transducers, etc. They do not have bus access authorization and may only acknowledge received data and transmit data upon request via the control bus subscriber.

The control bus subscriber may, for example, form a so-called MainDevice (abbreviated MDevice) and the subordinate bus subscriber may, for example, form a SubordinateDevice (abbreviated SubDevice). In other words, the control bus subscriber may dictate the communication behavior of the subordinate bus subscriber.

In automation systems, a programmable logic controller usually carries out control processes in a cyclical manner in order to generate output data for subordinate bus subscribers and/or other subordinate bus subscribers on the basis of input data from subordinate bus subscribers, which are sent by a control bus subscriber.

After completing a cyclical control process of the PLC, the control bus subscriber sends the output data in the form of Ethernet data packets or Ethernet frames (also referred to as Ethernet telegrams) via the field bus, wherein the subordinate bus subscribers extract the output data assigned to the respective subordinate bus subscriber from the Ethernet data packets and carry out a local subscriber process with this output data. The data determined by the local subscriber process is then transmitted by the subordinate bus subscribers to the control bus subscriber and subsequently transmitted to the PLC as input data for one of the next cyclic control processes and used by the control bus subscriber. In this context, the subordinate bus subscriber enters the input data into an Ethernet data packet sent by the control bus subscriber.

When using the real-time capable EtherCAT protocol in a control bus subscriber and subordinate bus subscriber system, the Ethernet data packets in which the EtherCAT datagrams are embedded are processed by the subordinate bus subscribers in passing. This means that processing takes place in parallel to the continuous receipt of a data packet. Each subordinate bus subscriber on the field bus is assigned its own data block area in the user data area of the data packet.

Instead of a control-bus-subscriber-subordinate-bus-subscriber system, a field-bus system may also be operated with a provider-consumer model. In the provider-consumer model, each subscriber, i.e., both the master bus subscriber and the slave bus subscribers, i.e., field devices on the field bus, offers data that may be requested by one or a plurality of the other bus subscribers. The data is provided in a cyclical manner. The real-time capable PROFINET protocol uses the provider-consumer model for Ethernet data packet exchange, for example, wherein the data packets also form Ethernet data packets. The data in the user data area of the Ethernet data packet is then for the consumer bus subscriber specified in the destination address.

An automation network usually comprises a plurality of bus subscribers, at least one of which is embodied as a control bus subscriber as mentioned above, and a plurality of bus subscribers are embodied as the aforementioned subordinate bus subscribers (subordinate devices). The control bus subscriber and the multiple subordinate bus subscribers are each connected to one another via at least one data line. The control bus subscriber may, for example, be software, i.e., a control program, for an industrial computer or an industrial controller for a plant or machine.

The connection of the plurality of subordinate bus subscribers via the at least one data line may be made in such a way that, for example, the arrangement of the subordinate bus subscribers deviates from a configuration sequence of the subordinate bus subscribers. The set-up sequence of the subordinate bus subscribers may correspond to a configured sequence of the subordinate bus subscribers in the control program, i.e., specify the sequence in which the subordinate bus subscribers are physically connected to the at least one data line.

However, the physical arrangement of the subordinate bus subscribers determines a processing sequence of the subordinate bus subscribers. The processing sequence is the sequence in which the subordinate bus subscribers process the data packets of the control bus subscriber.

If the set-up sequence and the processing sequence of the subordinate bus subscribers differ from each other, for example, because a subordinate bus subscriber is rotated with regard to its orientation, i.e., is connected to the at least one data line in reverse via a plurality of input/output ports of the subordinate bus subscriber, this may lead to serious impairments in the control process.

If the automation network with the plurality of subordinate bus subscribers, hereinafter referred to only as the plurality of bus subscribers, is embodied, for example, as at least one robot arm of an industrial robot, which is configured as a so-called “cobot” for direct interaction or collaboration with humans, the individual bus subscribers, as modules of the robot arm, which may form the above-mentioned plurality of bus subscribers, may not be correctly controlled for data processing if the processing sequence deviates from the set-up sequence. This may have extremely critical effects, particularly when interacting with humans, and poses an enormous potential hazard that must be avoided.

### SUMMARY

The invention provides an improved method for determining a bus subscriber arrangement in an automation network.

According to a first aspect, a method for determining a bus subscriber arrangement in an automation network is provided. The automation network includes a control bus subscriber and a plurality of bus subscribers, wherein the bus subscribers are connected to one another originating from the control bus subscriber via a data line network having at least one data line in a ring structure. Each bus subscriber comprises at least a first and a second input/output port, wherein the first input/output port and the second input/output port each comprise a receiving unit for receiving data packets and a transmitting unit for transmitting data packets. A data connection is provided between the receiving unit of the first input/output port and the transmitting unit of the second input/output port and between the receiving unit of the second input/output port and the transmitting unit of the first input/output port.

The data line comprises a forward path and a return path for data packets output by the control bus subscribers. The forward path for the data packets leads from the control bus subscriber to the receiving unit of the one input/output port of the first bus subscriber, extends via the data connection between the receiving unit of the one input/output port and the transmitting unit of the other input/output port of the first bus subscriber, leads from the transmitting unit of the other input/output port of the first bus subscriber to the receiving unit of the one input/output port of the next bus subscriber, extends over the data connection between the receiving unit of the one input/output port and the transmitting unit of the other input/output port of the next bus subscriber, and further extends from the transmitting unit of the other input/output port of the next bus subscriber, if a further bus subscriber is connected to the other input/output port via the data line, up to the last bus subscriber, to the other input/output port of which no bus subscriber is connected via the data line.

The data packets are routed from the forward path to the return path in the last bus subscriber. The return path extends via the data connection between the receiving unit of the other input/output port of the last bus subscriber and the transmitting unit of the one input/output port of the last bus subscriber, from the transmitting unit of the one input/output port of the last bus subscriber to the receiving unit of the other input/output port of the preceding bus subscriber, extends via the data connection between the receiving unit of the other input/output port and the transmitting unit of the one input/output port of the preceding bus subscriber, and leads from the transmitting unit of the one input/output port of the preceding bus subscriber via further preceding bus subscribers to the control bus subscriber.

The method comprises the following steps:
outputting a data packet via the control bus subscriber on the data line, wherein each bus subscriber records a forward timestamp upon receiving the data packet through the one input/output port on the forward path and a return timestamp upon receiving the data packet through the other input/output port on the return path,
correlating the recorded timestamps of each bus subscriber by forming a differential amount between the forward timestamp and the return timestamp of the bus subscriber is formed, wherein for the last bus subscriber, for which only a first timestamp is recorded, the second timestamp is set equal to the first timestamp,
sorting the differential amounts from the largest value to the smallest value in order to determine the set-up sequence of the bus subscribers, starting from the control bus subscriber as a set-up line of the bus subscribers.

According to a second aspect, a method for determining a bus subscriber arrangement in an automation network, comprising the following steps:
outputting a data packet via a control bus subscriber on a data line, wherein each bus subscriber records a forward timestamp upon receiving the data packet through the one input/output port on the forward path and a return timestamp upon receiving the data packet through the other input/output port on the return path;
correlating the recorded timestamps of each bus subscriber by forming a differential amount between the forward timestamp and the return timestamp of the bus subscriber, wherein for the last bus subscriber, for which only a first timestamp is recorded, the second timestamp is set equal to the first timestamp; and
sorting the differences from the largest value to the smallest value in order to determine the set-up sequence of the bus subscribers starting from the control bus subscriber as a set-up line of the bus subscribers.

According to a third aspect, an automation network includes a control bus subscriber and a plurality of bus subscribers. The bus subscribers are connected to one another originating from the control bus subscriber via a data line network having at least one data line in a ring structure. Each bus subscriber comprises at least a first and a second input/output port, wherein the first input/output port and the second input/output port each comprise a receiving unit for receiving data packets and a transmitting unit for transmitting data packets. A data connection is provided between the receiving unit of the first input/output port and the transmitting unit of the second input/output port and between the receiving unit of the second input/output port and the transmitting unit of the first input/output port.

The data line comprises a forward path and a return path for data packets output by the control bus subscribers. The forward path for the data packets leads from the control bus subscriber to the receiving unit of the one input/output port of the first bus subscriber, extends via the data connection between the receiving unit of the one input/output port and the transmitting unit of the other input/output port of the first bus subscriber, leads from the transmitting unit of the other input/output port of the first bus subscriber to the receiving unit of the one input/output port of the next bus subscriber, extends over the data connection between the receiving unit of the one input/output port and the transmitting unit of the other input/output port of the next bus subscriber, and further extends from the transmitting unit of the other input/output port of the next bus subscriber, if a further bus subscriber is connected to the other input/output port via the data line, up to the last bus subscriber, to the other input/output port of which no bus subscriber is connected via the data line.

The data packets are routed from the forward path to the return path in the last bus subscriber. The return path extends via the data connection between the receiving unit of the other input/output port of the last bus subscriber and the transmitting unit of the one input/output port of the last bus subscriber, from the transmitting unit of the one input/output port of the last bus subscriber to the receiving unit of the other input/output port of the preceding bus subscriber, extends via the data connection between the receiving unit of the other input/output port and the transmitting unit of the one input/output port of the preceding bus subscriber, and leads from the transmitting unit of the one input/output port of the preceding bus subscriber via further preceding bus subscribers to the control bus subscriber.

The control bus subscriber outputs a data packet via on the data line. Each bus subscriber records a forward timestamp upon receiving the data packet through the one input/output port on the forward path and a return timestamp upon receiving the data packet through the other input/output port on the return path. The control bus subscriber correlates the recorded timestamps of each bus subscriber by forming a differential amount between the forward timestamp and the return timestamp of the bus subscriber is formed, wherein for the last bus subscriber, for which only a first timestamp is recorded, the second timestamp is set equal to the first timestamp. The control bus subscriber sorts the differential amounts from the largest value to the smallest value in order to determine the set-up sequence of the bus subscribers starting from the control bus subscriber as an set-up line of the bus subscribers.

### Examples

An automation network comprises a control bus subscriber and a plurality of bus subscribers. The bus subscribers are connected to one another in a ring structure starting from the control bus subscriber via a data line network having at least one data line. Each bus subscriber comprises at least a first and second input/output port, wherein the first input/output port and the second input/output port each comprise a receiving unit for receiving data packets and a transmitting unit for transmitting data packets.

Between the receiving unit of the first input/output port and the receiving unit of the second input/output port a data line is provided, and between the receiving unit of the first output port and the receiving unit of the second output port a data line input/output port is provided, each having a receiving unit for receiving data packets and a transmitting unit for transmitting data packets. A data connection is provided between the receiving unit of the first input/output port and the transmitting unit of the second input/output port and between the receiving unit of the second input/output port and the transmitting unit of the first input/output port.

The data line comprises a forward path and a return path for data packets output by the control bus subscriber. The forward path for the data packets leads from the control bus subscriber to the receiving unit of the one input/output port of the first bus subscriber, extends via the data connection between the receiving unit of the one input/output ports and the transmitting unit of the other input/output port of the first bus subscriber, leads from the transmitting unit of the other input/output port of the first bus subscriber to the receiving unit of the one input/output port of the next bus subscriber, extends via the data connection between the receiving unit of the one input/output port and the transmitting unit of the other input/output port of the next bus subscriber, and further extending from the transmitting unit of the other input/output port of the next bus subscriber, if another bus subscriber is connected to the other input/output port via the data line, to the last bus subscriber, to the other input/output port of which no bus subscriber is connected via the data line.

In the last bus subscriber the data packets are routed from the forward path to the return path. The return path extends via the data connection between the receiving unit of the other input/output port of the last bus subscriber and the transmitting unit of the one input/output port of the last bus subscriber, leads from the transmitting unit of the one input/output port of the last bus subscriber to the receiving unit of the other input/output port of the preceding bus subscriber, extends over the data connection between the receiving unit of the other input/output port and the transmitting unit of the one input/output port of the preceding bus subscriber, and leads from the transmitting unit of the one input/output port of the preceding bus subscriber via further preceding bus subscribers to the control bus subscriber.

In order to determine a bus subscriber arrangement in the automation network, the following steps are carried out:
outputting a data packet via the control bus subscriber on the data line, wherein each bus subscriber records a forward timestamp upon receiving the data packet through the one input/output port on the forward path and a return timestamp upon receiving the data packet through the other input/output port on the return path,
correlating the recorded timestamps of each bus subscriber by forming a difference between the forward timestamp and the return timestamp of the bus subscriber, wherein for the last bus subscriber, for which only a first timestamp is recorded, the second timestamp is set equal to the first timestamp.
sorting the differential amounts starting from the largest value to the smallest value in order to determine the set-up sequence of the bus subscribers starting from the control bus subscriber as a set-up line of the bus subscribers.

Each bus subscriber may have a processing unit arranged in the data connection between the receiving unit of the first input/output port and the transmitting unit of the second input/output port in order to process data packets, wherein, when calculating the difference between the forward and the return timestamp of the bus subscriber is the first value of the timestamp assigned to the first input/output port and the second value of the timestamp assigned to the second input/output port of the bus subscriber, and wherein the sign of the difference between the timestamp assigned to the first input/output port and the timestamp assigned to the second input/output port is evaluated in order to determine the processing sequence of the bus subscribers within the set-up sequence of the bus subscribers.

The processing units in the bus subscribers may process the data packets in passing, wherein the EtherCAT transmission protocol is used as the communication protocol in the automation network.

The timestamps in the bus subscriber may be recorded using a clock function of the bus subscriber, wherein the clock function provides the bus subscriber with a local system time.

At least one bus subscriber may comprise a further second input/output port with a receiving unit for receiving data packets and a transmitting unit for transmitting data packets. The further second input/output port is arranged in the data connection between the receiving unit of the second input/output port and the transmitting unit of the first input/output port. The receiving unit of the second input/output port is connected to the transmitting unit of the further second input/output port and the receiving unit of the further second input/output port is connected to the transmitting unit of the first input/output port.

Further bus subscribers originating from the further second/output port may be integrated into the ring structure via the data line network via a further data line. The forward path for the data packets leads from the transmitting unit of the further second input/output port to the receiving unit of the one input/output port of a further bus subscriber, extends via the data connection between the receiving unit of the one input/output port and the transmitting unit of the other input/output port of the further bus subscriber, leads from the transmitting unit of the other input/output port of the first bus subscriber to the receiving unit of the one input/output port of the next bus subscriber, extends via the data connection between the receiving unit of the one input/output port and the transmitting unit of the other input/output port of the next bus subscriber, and further extends from the transmitting unit of the other input/output port of the next bus subscriber, if a further bus subscriber is connected to the other input/output port via the data line, to the last bus subscriber, to the other input/output port of which no bus subscriber is connected via the data line.

The data packets are routed from the forward path to the return path in the last bus subscriber. The return path extends via the data connection between the receiving unit of the other input/output port of the last bus subscriber and the transmitting unit of the one input/output port of the last bus subscriber, from the transmitting unit of the one input/output port of the last bus subscriber to the receiving unit of the other input/output port of the preceding bus subscriber, extends via the data connection between the receiving unit of the other input/output port and the transmitting unit of the one input/output port of the preceding bus subscriber, and leads from the transmitting unit of the one input/output port of the preceding bus subscriber via further preceding bus subscribers to the receiving unit of the further second input/output port.

The differential amounts formed between the forward timestamp and the return timestamp of the bus subscribers starting from the largest value to the smallest value, in order to determine the set-up sequence of the bus subscribers starting from the control bus subscriber, are sorted separately from the other bus subscribers for the bus subscribers connected to the further second input/output port in order to determine a further setup line of the bus subscribers starting from the further second input/output port.

The timestamps may each be stored in a memory unit of the bus subscriber. The control bus subscriber may read out the memory unit of the bus subscriber by sending a further data packet in order to obtain the recorded timestamps and determine the set-up sequence of the bus subscribers.

A method is proposed for determining a set-up sequence of bus subscribers in an automation network, wherein the automation network comprises a plurality of bus subscribers, each of which comprises a plurality of input/output ports. The method comprises the following steps:
providing a data packet to the plurality of bus subscribers in a first step,
wherein the plurality of bus subscribers are connected to one another via a data line network with at least one data line, which forms a forward path and/or a return path for the data packet,
receiving the data packet on the forward path via a first input/output port or a second input/output port of a bus subscriber and recording a first timestamp of the bus subscriber in a second step,
wherein the first input/output port and/or the second input/output port is connected to the at least one data line and the first timestamp of the bus subscriber is embodied to assign a unique point in time to the receipt of the data packet via the first input/output port as an event,
outputting the data packet via a second input/output port or first input/output port of the bus subscriber on a forward path to another bus subscriber in a third step,
receiving the data packet on a forward path via a first input/output port of the further bus subscriber and detecting a first timestamp of the further bus subscriber in a fourth step,
wherein the first timestamp of the further bus subscriber is embodied by assigning a unique time to the receipt of the data packet via the first input/output port of the further bus subscriber as an event,
receiving the data packet on a return path via the second input/output port of the bus subscriber via the at least one data line and recording a second timestamp of the bus subscriber in a fifth step,
wherein the second timestamp of the bus subscriber is embodied by assigning a unique time to the event of receiving the data packet via the second input/output port of the bus subscriber,
outputting the data packet via the first input/output port of the bus subscriber on the return path in a sixth step, and
correlating the first timestamp and the second timestamp of a bus subscriber in a seventh step in order to determine the sequence of the plurality of bus subscribers based thereon.

Furthermore, a method for controlling a plurality of bus subscribers of an automation network is proposed. The method for controlling the plurality of bus subscribers comprises the following steps:
providing a plurality of bus subscribers in an automation network in a first step,
carrying out a method for determining a set-up sequence of a plurality of bus subscribers of the automation network according to the above and/or following features in a second step, for assigning a processing sequence specifying the sequence in which the plurality of bus subscribers processes a data packet to the set-up sequence, i.e., the order in which the plurality of bus subscribers is physically connected to the at least one data line, and
controlling the plurality of bus subscribers in the automation network in a third step based on the determined set-up sequence of the bus subscribers in the second step.

In addition, a bus subscriber for an automation network is proposed, which is embodied in particular as a MainDevice, i.e., as a control bus subscriber for controlling and coordinating SubordinateDevices, i.e., subordinate bus subscribers. The bus subscriber embodied in particular as a main device is embodied to carry out a method for determining a set-up sequence of a plurality of bus subscribers of the automation network according to the above-mentioned and/or following features and/or a method for controlling a plurality of bus subscribers of an automation network according to the above-mentioned features.

Furthermore, a bus subscriber for an automation network is proposed which is embodied in particular as a subordinate device, i.e. as a subordinate bus subscriber which may be controlled by a main device, i.e. a control bus subscriber. The bus subscriber embodied in particular as a subordinate device comprises a plurality of input/output ports. A first input/output port and/or a second input/output port of the plurality of input/output ports are each connected to at least one data line in order to receive a data packet via the first input/output port or the second input/output port of the bus subscriber via the at least one data line on a forward path and to output the data packet via the second input/output port or the first input/output port via the at least one data line on the forward path to another bus subscriber.

The bus subscriber is embodied to record a first timestamp of the bus subscriber upon receiving the data packet via the first input/output port. The first timestamp of the bus subscriber is embodied to assign a unique time to the receipt of the data packet via the first input/output port of the bus subscriber as an event. Upon receiving the data packet via the second input/output port via the at least one data line of the data packet, the bus subscriber is embodied to record a second timestamp of the bus subscriber. The second timestamp of the bus subscriber is embodied to assign a unique time to the event of receiving the data packet via the second input/output port of the bus subscriber. The bus subscriber is embodied to output the data packet on the return path via the first input/output port or the second input/output port via the at least one data line.

Finally, an automation network is proposed. The automation network comprises a plurality of bus subscribers that are connected to one another via at least one data line. At least one bus subscriber of the plurality of bus subscribers is embodied according to the above features, in particular as a MainDevice, i.e., as a control bus subscriber for controlling and coordinating SubordinateDevices, i.e., subordinate bus subscribers. At least one bus subscriber of the plurality of bus subscribers is embodied according to the above and/or following features, in particular as a subordinate device, i.e., as a subordinate bus subscriber that may be controlled by a main device, i.e., a control bus subscriber.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic depiction of a method for determining a sequence of bus subscribers in an automation network according to a first embodiment.

FIG. 2 shows a schematic depiction of a section of the method in FIG. 1.

FIG. 3 shows a schematic depiction of a method for determining a sequence of bus subscribers in an automation network according to a second embodiment.

FIG. 4 shows a schematic depiction of a method for determining a sequence of bus subscribers in an automation network according to a third embodiment.

FIG. 5 is a schematic depiction of a method for determining a sequence of bus subscribers in an automation network according to a fourth embodiment.

FIG. 6 is a schematic depiction of a method for determining a sequence of bus subscribers in an automation network according to a fifth embodiment.

FIG. 7 is a schematic depiction of a method for controlling a plurality of bus subscribers in an automation network.

FIG. 8 is a schematic depiction of a bus subscriber for an automation network according to a first embodiment.

FIG. 9 is a schematic depiction of a bus subscriber for an automation network according to a second embodiment.

FIG. 10 is a schematic depiction of a bus subscriber for an automation network according to a third embodiment.

FIG. 11 is a schematic depiction of an automation network according to a first embodiment.

FIG. 12 is a schematic depiction of an automation network according to a second embodiment.

FIG. 13A shows a schematic first depiction of an automation network according to a third embodiment.

FIG. 13B shows a schematic second depiction of the automation network according to the third embodiment in FIG. 13A.

FIG. 14A shows a first schematic depiction of an automation network according to a fourth embodiment.

FIG. 14B is a second schematic depiction of the automation network according to the fourth embodiment.

FIG. 15A is a schematic first depiction of an automation network according to a fifth embodiment.

FIG. 15B is a schematic second depiction of an automation network according to a fifth embodiment.

FIG. 16A shows a schematic first depiction of an automation network according to a sixth embodiment.

FIG. 16B is a schematic second depiction of an automation network according to a sixth embodiment.

FIG. 17A is a schematic depiction of a first timeline for detected timestamps.

FIG. 17B is a schematic depiction of a second timeline for detected timestamps.

It should be noted that the figures are merely schematic in nature and not to scale. In this context, components and elements shown in the figures may be exaggeratedly large or small for better understanding. It should also be noted that the reference numerals in the figures have been chosen in such a way that they remain unchanged or are similar when they refer to elements and/or components of the same or similar embodiment.

### DETAILED DESCRIPTION

The term “MainDevice” (abbreviated “MDevice”) refers to a “control bus subscriber” that is embodied to control and coordinate “SubordinateDevices” in the automation network. A “MainDevice” therefore forms the central controller/main device of a system or machine in an automation network, which takes over the control and coordination of the subordinate bus subscribers. The terms “MainDevice” and “control bus subscriber” may be understood as synonyms.

The term “subordinate device” (or “SubDevice” for short) refers to a subordinate bus subscriber that may be controlled by a “main device,” i.e., a “control bus subscriber,” wherein “controllable” also includes “configurable.” A “SubDevice” is therefore a subordinate unit in a system or machine that may be controlled by the main device, i.e., the “MainDevice.” The “SubDevice” processes the data packets sent by the “MainDevice,” e.g., Ethernet data packets, and carries out the tasks specified in the data packet while the “SubDevice” forwards the data packet as it passes through.

“Control process” refers to the general, cyclically performed control operation of the automation network.

A “first arrangement” of a bus subscriber specifies that a data packet first passes through the first input/output port of the bus subscriber on the forward path. This means that in the first arrangement, the first input/output port of the bus subscriber faces the control bus subscriber. It is understood that on the return path, the data packet first passes through the second input/output port of the bus subscriber having the first arrangement.

A “second arrangement” of a bus subscriber specifies that a data packet first passes through the second input/output port of the bus subscriber on the forward path. This means that in the second arrangement, the second input/output port of the bus subscriber faces the control bus subscriber. It is understood that on the return path, the data packet first passes through the first input/output port of the bus subscriber having the second arrangement.

A “set-up sequence” of a plurality of bus subscribers specifies the sequence in which the plurality of bus subscribers is physically connected to the at least one data line. A data packet passes through the plurality of bus subscribers according to the set-up sequence.

A “processing sequence” of a plurality of bus subscribers specifies the sequence in which the plurality of bus subscribers process a data packet, i.e., read data, write data, etc. The processing sequence may differ from the set-up sequence for a bus subscriber, e.g., if this bus subscriber comprises the second arrangement. If the bus subscriber comprises the first arrangement, the processing sequence and the set-up sequence of the bus subscriber may be the same.

A “first timestamp” assigns a unique time to the receipt of a data packet via a first input/output port of a bus subscriber via at least one data line as an event. This unique time is taken into account in the course of a procedure for determining a set-up sequence of bus subscribers in an automation network. If the bus subscriber comprises the second arrangement, the bus subscriber may receive the data packet via the second input/output port and first record a second timestamp for the receipt of the data packet via the second input/output port.

A “second timestamp” assigns a unique time to the receipt of a data packet via a second input/output port of a bus subscriber via at least one data line as an event. This unique time is taken into account in a process for determining a sequence of bus subscribers in an automation network. The at least one data line may be embodied as a separate forward data line and a separate return data line, wherein the forward data line forms, for example, the forward path of the data packet, and the return data line forms, for example, the return path of the data packet. If a bus subscriber generally comprises no other connected bus subscribers at the second input/output port of the bus subscriber in the first arrangement, the second timestamp is set equal to the first timestamp, i.e., the second timestamp corresponds to the first timestamp. It is understood that this also applies in a similar manner to the second arrangement.

A “third timestamp” assigns a unique time to the receipt of a data packet via a third input/output port of a bus subscriber on a return path of the data packet as an event.

A “fourth timestamp” assigns a unique time to the event of receiving a data packet via a fourth input/output port of a bus subscriber on a return path of the data packet.

The new idea is to use an existing clock functionality of a bus subscriber to record at least a first timestamp upon receipt of a data packet via a first input/output port of a bus subscriber of the data packet and a second timestamp upon receipt of the data packet via a second input/output port of the bus subscriber of the data packet.

Based on the recorded at least first and second timestamps of a bus subscriber, the physical connection sequence of the bus subscribers to the at least one data line may be determined by applying the proposed method for determining a set-up sequence of bus subscribers and the associated devices. The processing sequence of the bus subscribers with which the bus subscribers process the data packets may be assigned to the determined set-up sequence.

If the processing sequence and the set-up sequence of a bus subscriber match, the bus subscriber may have a first arrangement, wherein the first arrangement specifies that a data packet passes through the corresponding bus subscriber, first passing through the first input/output port of the bus subscriber on the forward path. This means that in the first arrangement, the first input/output port of the bus subscriber faces the control bus subscriber. It is understood that on the return path, the data packet first passes through the second input/output port of the bus subscriber having the first arrangement.

Mathematically, the difference between the time of receipt of the data packet at the second input/output port and the time of receipt of the data packet at the first input/output port is calculated and the sign is evaluated. That is, the receipt time of the second timestamp for the receipt of the data packet via the second input/output port minus the receipt time of the first timestamp for the receipt of the data packet via the first input/output port. The receipt time or the second timestamp of a data packet at the second input/output port of a bus subscriber is larger than the receipt time or the first timestamp of a data packet at the first input/output port of the bus subscriber.

If the set-up sequence and the processing sequence differ from each other, the bus subscriber may have a second arrangement, wherein the second arrangement specifies that a data packet first passes through the second input/output port of the bus subscriber on the forward path. This means that in the second arrangement, the second input/output port of the bus subscriber faces the control bus subscriber. It is understood that on the return path, the data packet first passes through the first input/output port of the bus subscriber having the second arrangement.

Mathematically, the difference between the time of receipt of the data packet at the second input/output port and the time of receipt of the data packet at the first input/output port is calculated, and the sign is evaluated. That is, the receipt time of the first timestamp for the receipt of the data packet via the second input/output port minus the receipt time of the second timestamp for the receipt of the data packet via the first input/output port. The receipt time or the first timestamp of a data packet at the second input/output port of a bus subscriber having the second arrangement is smaller than the receipt time or the second timestamp of a data packet at the first input/output port of the bus subscriber.

The proposed methods and devices are advantageously suitable for all automation networks and bus subscribers that are traversed by a data packet on the forward and return paths. The forward and return paths may each be formed by separate data lines. However, the automation network is preferably embodied to use the EtherCAT transmission protocol as the communication protocol.

The present idea helps to improve the safety of the automation network if the automation network is embodied, for example, as at least one robot arm, i.e., as a cobot for interaction with humans. Based on the proposed method, it is irrelevant whether a bus subscriber comprises the first arrangement or the second arrangement, since the set-up sequence of the bus subscribers is recorded and the processing sequence may be assigned to the recorded set-up sequence. It is not necessary to change the set-up sequence of the bus subscribers already specified in the control program. Instead, the set-up sequence of the bus subscribers is reliably retained. The method for detecting the set-up sequence of bus subscribers is advantageous not only for maintenance purposes but also for determining the arrangement of bus subscribers in a simple manner in general.

In a further embodiment, the first timestamp and the second timestamp may be detected on the basis of a clock functionality of a bus subscriber. The clock functionality provides the bus subscriber with a local system time and may be embodied as a hardware-implemented local clock. A processing unit of the bus subscriber, which is embodied in particular as a subordinate bus subscriber, may, for example, have the hardware-implemented local clock with a range of 64 bits and a resolution of 1 bit=1 ns.

This has the advantage that known and established technology may be used. The local clock functionality is known in automation networks which use, for example, the real-time EtherCAT transmission protocol under the term “distributed clocks” and stands for a logical network of distributed clocks that allows for synchronizing the local time of all bus subscribers to the same time.

A subordinate bus subscriber that supports the “distributed clocks functionality” comprises its own clock, which initially operates locally after being switched on, based on its own clock generator (e.g., quartz, oscillator, etc.). A selected subordinate bus subscriber from the majority of bus subscribers in the automation network represents the reference clock, to which the clocks of the other subordinate bus subscribers and the control bus subscriber are synchronized. The reference clock thus represents the system time.

The control bus subscriber automatically and continuously coordinates and synchronizes the individual clocks if it supports the “distributed clocks” functionality—such as the control bus subscriber by Beckhoff TwinCAT EtherCAT MainDevice. To do this, the EtherCAT MainDevice sends a special EtherCAT datagram at short intervals, into which the EtherCAT SubDevice with the reference clock enters its current time. The short intervals are so frequent that the clocks of the subordinate bus subscribers do not diverge within the specified limits. This information is then read by all other EtherCAT SubDevices with their own subordinate clock from the same circulating datagram.

This is possible due to the ring structure of an EtherCAT automation network if the reference clock is topologically arranged in front of all other clocks of the SubDevices. The ring structure refers to a first data line that forms a forward path for the circulating Ethernet data packet, comprising EtherCAT datagrams, and a second data line that forms a return path for the Ethernet data packet, with the individual SubDevices being connected to one another via the first and second data lines. For this reason, the first “Distributed Clocks” capable SubDevice is selected as the reference clock by the EtherCAT control bus subscriber by default.

In summary, one of the EtherCAT SubDevices contains the reference clock, while all other EtherCAT bus subscribers, including the EtherCAT main device, are subordinate clocks. The Distributed Clocks functionality allows incoming events to be provided with an accurate timestamp, i.e., they may be latched or provided with latch signals, and synchronous output signals may be generated.

However, the proposed method for recording the set-up sequence and the proposed automation network comprising the plurality of bus subscribers does not use synchronized distributed clock functionality as described above but instead exploits the fact that a bus subscriber comprises clock functionality, i.e., a local clock. This local clock is used to detect the first and second timestamps, as well as the third and fourth timestamps, for more than two input/output ports of a bus subscriber, i.e., the respective receipt time is latched by the bus subscriber. It goes without saying that this feature is not limited to automation networks that use the EtherCAT transmission protocol but may also be implemented in other automation networks.

In a further embodiment of the method for determining a set-up sequence of the bus subscribers, the at least one data line is embodied as a forward data line and a return data line, which are connected to the first and second input/output ports of a bus subscriber of the plurality of bus subscribers, respectively. The forward data line forms the forward path of the data packet, and the return data line forms the return path of the data packet. A processing unit is arranged between the first input/output port of the bus subscriber and the second input/output port of the bus subscriber. The processing unit is in particular connected to the forward data line on the forward path of the data packet. The bus subscriber is embodied to record the first timestamp upon receipt of a data packet via the first input/output port and the forward data line of the data packet and to forward the data packet in particular via the forward data line to the processing unit.

The processing unit is embodied to process the data packet in real time, i.e., in parallel with the continuous receipt of the data packet via the first input/output port, and in particular, to forward the data packet via the forward data line to the second input/output port of the bus subscriber. The bus subscriber is embodied to output the data packet via the second input/output port via the forward data line to another bus subscriber connected via the second input/output port. Upon receiving the data packet via the return data line, the bus subscriber is embodied to detect the second timestamp and output the data packet via the first input/output port and the return data line on the return path.

The automation network preferably uses the EtherCAT transmission protocol in order to be able to utilize established technology. The handling of EtherCAT communication and, in particular, the “distributed clocks” functionality in a bus subscriber embodied as an EtherCAT SubDevice is handled by the processing unit, which is preferably embodied as an EtherCAT SubDevice controller, i.e., as an electronic component that may be implemented as an ASIC or programmable FPGA or similar.

Each EtherCAT SubDevice comprises such a processing unit embodied as an ESC so that cyclic and acyclic process data may be exchanged between the main device and the SubDevice via the EtherCAT field bus, i.e., for example, the first and second data lines. The ESC may also manage port information that provides details about the number of input/output ports on a SubDevice. The ESC thus manages the local “distributed clocks” functionality, i.e., the hardware-implemented local clock with a range of 64 bits (less commonly: 32 bits) and a resolution of 1 bit=1 ns, with the associated actions, provided that the EtherCAT SubDevice supports this functionality.

In a further embodiment of the method for determining the set-up sequence, the relating in the seventh step comprises forming a difference between the second timestamp for receiving the data packet via the second input/output port and the first timestamp for receiving the data packet via the first input/output port of a bus subscriber. This advantageously allows the use of simple mathematics or, respectively, simple operations and reduces the computational effort. This increases performance and allows for results to be obtained quickly.

If a bus subscriber generally has no other connected bus subscribers at the second input/output port of the bus subscriber in the first arrangement, then the second timestamp of the bus subscriber is set equal to the first timestamp of the bus subscriber, i.e., the second timestamp corresponds to the first timestamp. It is understood that this also applies in a similar manner to the second arrangement of a bus subscriber. For such a bus subscriber, the aforementioned difference may be calculated without any problems, and the advantages described above apply accordingly.

In a further embodiment of the method for determining a set-up sequence, the difference determined in the seventh step is evaluated by taking a sign into account. If the sign is positive, a bus subscriber is arranged in such a way that the processing sequence corresponds to the set-up sequence. The set-up sequence is the sequence in which the bus subscribers are physically connected to at least one data line, and the processing sequence specifies the sequence in which the bus subscribers process a data packet. Alternatively, if the sign is negative, a bus subscriber is arranged in such a way that the processing sequence and the set-up sequence differ from each other.

The processing sequence of the bus subscribers may be easily determined by considering the sign of the difference formed in the seventh step. By forming the amounts of the differences and sorting the amounts, the assembly order of the bus subscribers may be easily determined.

In a further embodiment of the method for determining a set-up sequence, the seventh step further comprises forming an amount of the determined difference per bus subscriber, wherein the set-up sequence of the bus subscribers may be determined. The amounts formed are sorted for the plurality of bus subscribers, in particular, sorted in ascending order. The smaller the amount of the determined difference, the further away the respective bus subscriber is located from a bus subscriber providing a data packet in the first step.

By sorting the amounts, the sequence of bus subscribers may easily be determined. The larger the amount, the closer the bus subscriber is located to the control bus subscriber. The smaller the amount, the further away. The processing order may be determined by considering the sign of the difference formed in the seventh step. This advantageously allows the use of simple mathematics or simple operations and reduces the computational effort. This increases performance and allows for results to be obtained quickly.

In a further embodiment of the method for determining a set-up sequence, the plurality of bus subscribers may be arranged individually or in modules of a plurality of bus subscribers each.

Advantageously, a specific arrangement of the bus subscribers is not necessary for applying the method for determining the set-up sequence of the bus subscribers, since, based on the proposed method, a deliberate swapping of individual bus subscribers as well as a deliberate swapping of entire modules, each grouped into a plurality of bus subscribers, may be detected. Thus, the proposed method and the associated devices may be used flexibly.

In a further embodiment of the automation network, the automation network having the plurality of bus subscribers is embodied as at least one robot arm of an industrial robot, comprising a plurality of movable axes. The plurality of movable axes of the at least one robot arm are each embodied as individual bus subscribers, the set-up sequence of which may be determined using a method for determining the set-up sequence of the plurality of bus subscribers according to the above-mentioned and/or following features and/or which may be controlled using a method for controlling the plurality of bus subscribers according to the above-mentioned features in accordance with the set-up sequence of the plurality of bus subscribers. The set-up sequence specifies the sequence in which the plurality of bus subscribers is physically connected to the at least one data line.

In this way, the safety of the automation network may be advantageously improved, in particular when the automation network is configured as at least one robot arm, i.e., as a cobot. This is because, based on the proposed methods and devices, it is possible, for example, to reliably control the individual axes of at least one robot arm or, in general, it is possible to reliably control the bus subscribers or the modules, regardless of whether the majority of bus subscribers comprise the first arrangement or the second arrangement.

In a further embodiment of the automation network, the majority of bus subscribers of the automation network may be arranged in modules, each comprising a plurality of bus subscribers. The modules particularly form tables.

In this way, the safety of the automation network may be advantageously improved, in particular when the modules of the automation network are embodied as tables. This is because, based on the proposed methods and devices, reliable control of the modules, e.g., as tables, comprising a plurality of bus subscribers each is possible—or, in general, reliable control of the bus subscribers is possible.

In a further embodiment of the method for determining the set-up sequence and the bus subscriber, a processing unit is arranged between the first input/output port of the bus subscriber and the second input/output port of the bus subscriber. The processing unit is in particular connected to a forward data line on a forward path of the data packet. The bus subscriber is embodied to detect the first timestamp upon receipt of a data packet via the first input/output port and the first data line of the data packet and to forward the data packet in particular via the forward data line to the processing unit.

The processing unit is embodied to process the data packet in real time, i.e., in parallel with the continuous receipt of the data packet via the first input/output port, and in particular, to forward the data packet via the forward data line to the second input/output port of the bus subscriber. The bus subscriber is embodied to output the data packet via the second input/output port via the first line to the other bus subscriber connected via the second input/output port. Upon receiving the data packet via the return data line, the bus subscriber is embodied to record the second timestamp and output the data packet via the first input/output port and the return data line on the return path.

The processing of a data packet as it passes through a processing unit of a bus subscriber takes place on the forward path of the data packet, provided that the processing unit is passed through on the forward path of the data packet. In this case, a bus subscriber comprises the first arrangement. If a bus subscriber comprises the second arrangement, the processing unit is only passed through by the data packet on the return path, and the processing of the data packet is carried out by the processing unit on the return path of the data packet. This improves the traceability and transparency of the automation network, including all bus subscribers.

In a further embodiment of the method for determining the set-up sequence, the bus subscriber and the further bus subscribers connected via the first or second input/output port of the bus subscriber via the at least one data line form a first line, provided that the bus subscriber comprises a third input/output port to which at least one first further bus subscriber is connected via at least one further data line. The at least one first further bus subscriber connected via a third input/output port of the bus subscriber via the at least one further data line forms a second line. The at least one further data line forms a forward path and/or a return path for the data packet.

The proposed methods and devices are advantageously not limited to bus subscribers with a specific number of input/output ports, but may be used flexibly for different embodiments. This facilitates compatibility and improves clarity and traceability when grouping the bus subscribers connected via the input/output ports into different lines. The individual bus subscribers of a line may be recorded as desired. In addition, it is possible to output a separate data packet for each line from the control bus subscriber.

In a further embodiment of the proposed method and the proposed bus subscriber, the bus subscriber is embodied to record the first timestamp when it receives the data packet via the first input/output port and to output the data packet via the first line on the forward path, so that a bus subscriber on the first line may detect the first timestamp and/or the second timestamp. The bus subscriber is embodied to output the data packet upon receipt on the return path via the first line, via the second input/output port of the bus subscriber and via a third input/output port of the bus subscriber to a second line on the forward path so that at least one further first bus subscriber on the second line may detect the first timestamp and/or the second timestamp. If the bus subscriber receives the data packet via the third input/output port on the return path of the second line, the bus subscriber is embodied to detect a third timestamp and output the data packet via the first input/output port on the return path via the first line.

If the bus subscriber comprises the second arrangement, the bus subscriber is embodied, if the bus subscriber receives the data packet via the second input/output port to detect the second timestamp and outputs the data packet via the third input/output port via the second line on the forward path, then at least one first further bus subscriber on the second line may detect the first timestamp and/or the second timestamp. Upon receiving the data packet on the return path via the second line via the third input/output port of the bus subscriber, the bus subscriber is embodied to detect a third timestamp and output the data packet via the first input/output port to the first line on the forward path. A bus subscriber on the first line may then detect the first timestamp and/or the second timestamp. The bus subscriber is embodied so that, if the bus subscriber receives the data packet via the first input/output port on the return path of the first line, it records the first timestamp and outputs the data packet via the second input/output port on the return path via the first line.

Advantageously, a third timestamp may be recorded according to the same principle as the first and second timestamps. However, the third timestamp is not included in the above-mentioned difference calculation in the seventh step of the bus subscriber recognition process. This is because the third timestamp is only recorded when the data packet is received via the third input/output port of the bus subscriber on the return path, whereas no separate timestamp is recorded for the receipt of the data packet on the forward path via the third input/output port. This has already been recorded as the second timestamp when the data packet is received via the second input/output port of the bus subscriber. The internal forwarding of the data packet to the corresponding ports is therefore not included in the difference calculation in the seventh step as mentioned above.

In a further embodiment of the method for determining the set-up sequence, the bus subscriber and the further bus subscribers connected via the first input/output port of the bus subscriber via the at least one data line form a first line, provided that the bus subscriber comprises a third input/output port and a fourth input/output port, to each of which at least one further bus subscriber is connected via at least one further data line. The at least one first further bus subscriber connected via the third input/output port of the bus subscriber via the at least one first further data line forms a second line. The at least one second further bus subscriber connected via the fourth input/output port of the bus subscriber via the at least one second further data line forms a third line. The at least one first further data line forms a forward path and/or a return path for the data packet. The at least one second further data line forms a forward path and/or a return path for the data packet.

The proposed methods and devices are advantageously not limited to bus subscribers with a specific number of input/output ports but may be used flexibly for different embodiments. This facilitates compatibility and improves clarity and traceability when grouping the bus subscribers connected via the input/output ports into different lines. The individual bus subscribers of a line may be recorded as desired. In addition, it is possible to output a separate data packet from the control bus subscriber for each line.

In a further embodiment of the method for determining the set-up sequence of bus subscribers and the bus subscriber, the bus subscriber comprises a third input/output port and a fourth input/output port, to each of which at least one further bus subscriber is connected via at least one further data line.

The bus subscriber and the further bus subscribers connected via the first input/output port or second input/output port of the bus subscriber via at least one data line form a first line. The at least one first further bus subscriber connected via the third input/output port via the at least one first further data line forms a second line. The at least one second further bus subscriber connected via the fourth input/output port of the bus subscriber via the at least one second further data line forms a third line. A processing unit is arranged between the first input/output port of the bus subscriber and the third input/output port of the bus subscriber. The processing unit is connected to the forward data line on the forward path of the data packet.

The bus subscriber is embodied, insofar as the bus subscriber receives the data packet via the first input/output port, to record the first timestamp and to forward the data packet in particular via the forward data line to the processing unit. The processing unit is embodied to process the data packet in real time, i.e., in parallel with the continuous receipt of the data packet via the first input/output port, and in particular for forwarding the data packet via the forward data line to the fourth input/output port for outputting the data packet via the third line on the forward path via the fourth input/output port, so that the at least one second further bus subscriber on the third line may detect a first timestamp and/or a second timestamp.

The bus subscriber is embodied to detect a fourth timestamp on the return path via the third line upon receipt of the data packet via the fourth input/output port and to output the data packet via the second input/output port to the first line on the forward path so that a bus subscriber on the first line may detect the first timestamp and/or the second timestamp. If the bus subscriber receives the data packet via the second input/output port, the bus subscriber is embodied to detect a second timestamp and output the data packet via the third input/output port on the forward path to the at least one first further bus subscriber of the second line, so that the at least one first further bus subscriber of the second line may detect a first timestamp and/or a second timestamp. The bus subscriber is embodied in such a way that, if the bus subscriber receives the data packet via the third input/output port on the return path of the second line, it detects a third timestamp and outputs the data packet via the first input/output port on the return path via the first line.

If the bus subscriber, comprising four input/output ports, comprises the second arrangement, the bus subscriber is embodied in such a way that, if the bus subscriber receives the data packet via the second input/output port, it detects the second timestamp and outputs the data packet via the second line on the forward path via the third input/output port so that at least one first further bus subscriber on the second line may detect a first timestamp and/or a second timestamp. The processing unit is not passed through on the forward path of the data packet but on the return path, so that the processing unit processes the data packet on the return path. Upon receipt of the data packet via the third input/output port of the bus subscriber on the return path via the second line, the bus subscriber detects the third timestamp and outputs the data packet via the first input/output port to the first line on the forward path so that a bus subscriber on the first line may detect the first timestamp and/or the second timestamp.

If the bus subscriber receives the data packet via the first input/output port, the first timestamp is recorded by the bus subscriber, and the data packet is output via the fourth input/output port on the forward path to the at least one second further bus subscriber of the third line on the forward path, so that the at least one second further bus subscriber of the third line may detect a first timestamp and/or a second timestamp. If the bus subscriber receives the data packet via the fourth input/output port on the return path of the third line, the bus subscriber is embodied to detect a fourth timestamp and output the data packet via the second input/output port on the return path via the first line.

Advantageously, a third and fourth timestamp may each be recorded according to the same principle as the first and second timestamps. However, the third and fourth timestamps are not included in the above-mentioned difference formation in the seventh step of the method for recognizing the bus subscribers. This is because the third timestamp is only recorded when the data packet is received via the third input/output port of the bus subscriber on the return path. Similarly, the fourth timestamp is only recorded when the data packet is received via the fourth input/output port on the return path. If the bus subscriber comprises the second arrangement, i.e., the processing unit is only passed through by the data packet on the return path, the data packet is processed on the return path by the processing unit. This improves the traceability and transparency of the automation network, including all bus subscribers.

In a further embodiment of the method for determining a set-up sequence, separate data packets may be output for the first line and/or for the second line and/or for the third line.

This advantageously improves traceability and transparency.

In a further embodiment of the method for determining a sequence of bus subscribers and the bus subscriber, the first to fourth timestamps may each be stored in a memory unit, in particular a register unit, of a bus subscriber.

The bus subscriber may comprise a memory unit, in particular a register unit, which may be accessed by the processing unit of the bus subscriber. It is also conceivable that the processing unit of the bus subscriber itself comprises the memory unit. The control bus subscriber may, for example, read out the memory unit of a bus subscriber by sending a further data packet in order to obtain the recorded timestamps and, based on these, carry out the seventh step of the method for determining the order of the bus subscribers.

In a further embodiment of the method for determining the set-up sequence of bus subscribers and of the proposed bus subscriber, a further data packet is output to the plurality of bus subscribers in order to read out the memory units, in particular register units, of the plurality of bus subscribers with the first to fourth timestamps of the plurality of bus subscribers and, based on this, to correlate the first timestamp of a bus subscriber with the second timestamp of a bus subscriber.

This advantageously improves traceability and transparency.

In a further embodiment of the method for determining the set-up sequence of bus subscribers, the second step of the method for determining the set-up sequence also includes processing the data packet, provided that the bus subscriber is arranged in such a way that the processing sequence of the bus subscriber corresponds to the set-up sequence of the bus subscriber.

Advantageously, provided that the corresponding bus subscriber is addressed, the bus subscriber may write or read data in the second step of the above-mentioned method that is relevant, for example, for the control cycle.

In a further embodiment of the method, the processing sequence of the plurality of bus subscribers is recorded by reading a first data field and/or a second data field and/or a third data field of an identification object and/or port information. The identification object forms a communication object that comprises a plurality of data fields for identifying a bus subscriber. For example, the identification object of a bus subscriber may be stored in a memory unit of the bus subscriber, which may be read out by outputting a data packet from the control bus subscriber to the bus subscriber so that the control bus subscriber may identify the number of input/output ports of a bus subscriber as well as the bus subscriber itself. The first data field of the identification object is embodied as a product identifier for the bus subscriber, the second data field of the identification object is embodied as a version number for the bus subscriber, and the third data field is embodied as a manufacturer identifier for the bus subscriber. The port information specifies how many input/output ports a bus subscriber has.

The individual bus subscribers in the automation network may be identified for the various transmission protocols and access methods, regardless of the hierarchical structure of the automation network, via the so-called identification object of a bus subscriber. The identification object (or so-called “identity object”) forms a communication object that may comprise one or a plurality of data fields for identifying a bus subscriber. The first data field of the identification object may be embodied as a product identifier (so-called “product code”) of the bus subscriber, the second data field of the identification object may be embodied as a version number (so-called “revision number”) of the bus subscriber, and the third data field may be embodied as a manufacturer identifier (so-called “vendor ID”) of the bus subscriber. In addition, a fourth data field may form a serial number. The first to fourth data fields may each comprise UINT32 values. The version number may, for example, have a first data word (“Lo-Word”, bits 0-15) and a second data word (“Hi-Word”, bits 16-31).

The new idea is to use an existing clock functionality of a bus subscriber to record at least a first timestamp upon receipt of a data packet via a first input/output port of a bus subscriber and a second timestamp upon receipt of the data packet via a second input/output port of the bus subscriber. If the bus subscriber comprises the second arrangement, the existing clock functionality is used to first record the second timestamp upon receipt of a data packet via the second input/output port of the bus subscriber and to record the first timestamp upon receipt of the data packet via the first input/output port of the bus subscriber on the return path of the data packet. The clock functionality provides the bus subscriber with a local system time and may be embodied as a hardware-implemented local clock in the bus subscriber, e.g., with a range of 64 bits and a resolution of 1 bit=1 ns.

Based on the recorded at least first and second timestamps, the proposed method for determining a set-up sequence of bus subscribers and the associated devices may be used to determine the set-up sequence of the bus subscribers, i.e., the sequence in which the bus subscribers are connected to the at least one data line and are passed through by a data packet. The processing sequence, i.e., the sequence in which the bus subscribers process a data packet, may be assigned to the set-up sequence.

The set-up sequence of the bus subscribers may be determined in a simple manner by considering a sign of the difference formed when applying the method for determining the set-up sequence of the bus subscribers and by forming amounts of the differences and sorting the amounts. The larger the amount, the closer the bus subscriber is located to the control bus subscriber. The smaller the absolute value, the further away.

If the processing sequence and the set-up sequence of a bus subscriber match, the bus subscriber may comprise the first arrangement, wherein the first arrangement specifies that a data packet first passes through the first input/output port of the bus subscriber on the forward path. This means that in the first arrangement, the first input/output port of the bus subscriber faces the control bus subscriber. It goes without saying that on the return path, the data packet first passes through the second input/output port of the bus subscriber comprising the first arrangement.

Mathematically, the difference between the time of receipt of the data packet at the second input/output port of the bus subscriber and the time of receipt of the data packet at the first input/output port of the bus subscriber is calculated and the sign is evaluated. This means the second timestamp for the receipt of the data packet via the second input/output port of the bus subscriber minus the first timestamp for the receipt of the data packet via the first input/output port of the bus subscriber. The receipt time or the second timestamp of a data packet at the second input/output port of a bus subscriber with the first arrangement is larger than the receipt time or the first timestamp of a data packet at the first input/output port of the bus subscriber. In this case, the sign would be positive and would indicate the first arrangement of the bus subscriber.

If the set-up sequence and the processing sequence differ from each other, the bus subscriber may have a second arrangement, wherein the second arrangement indicates that a data packet first passes through the second input/output port of the bus subscriber on the forward path. This means that in the second arrangement, the second input/output port of the bus subscriber faces the control bus subscriber. It is understood that on the return path, the data packet first passes through the first input/output port of the bus subscriber having the second arrangement.

Mathematically, the difference between the time of receipt of the data packet at the second input/output port of the bus subscriber and the time of receipt of the data packet at the first input/output port of the bus subscriber is calculated and the sign is evaluated. This means the second timestamp for the receipt of the data packet via the second input/output port of the bus subscriber with the second arrangement minus the first timestamp for the receipt of the data packet via the first input/output port. The receipt time or the second timestamp of a data packet at the second input/output port of a bus subscriber with the second arrangement is smaller than the receipt time or the first timestamp of a data packet at the first input/output port of the bus subscriber. In this case, the sign mentioned would be negative and would indicate the second arrangement of the bus subscriber.

The proposed methods and devices are advantageously suitable for all automation networks and bus subscribers that are passed through by a data packet on the forward and return paths. The forward and return paths may each be formed by separate data lines. However, the automation network is preferably embodied to use the EtherCAT transmission protocol as the communication protocol.

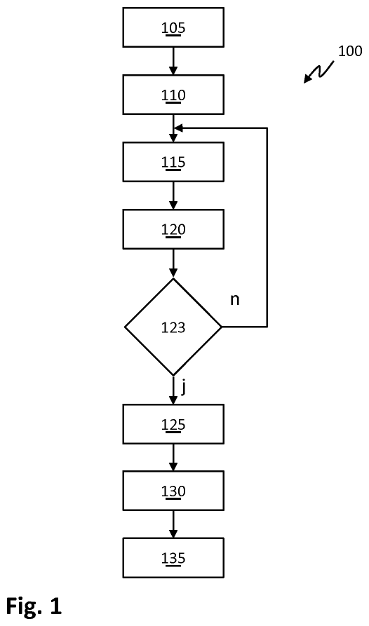

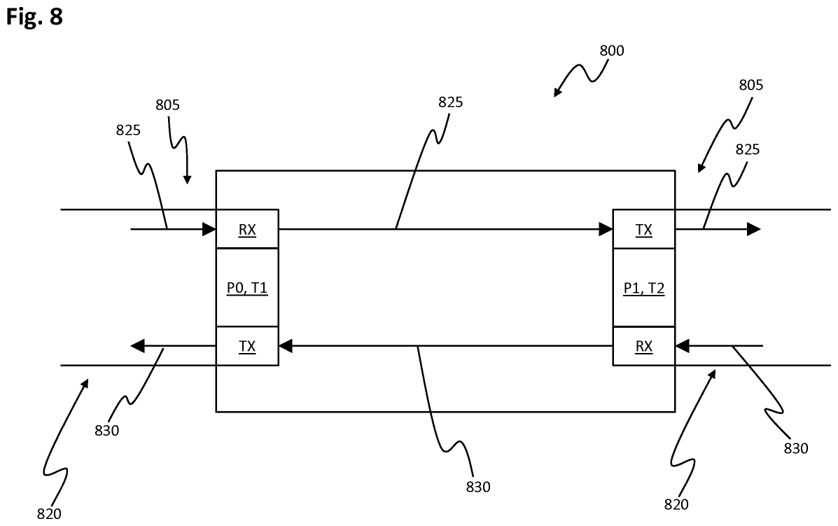

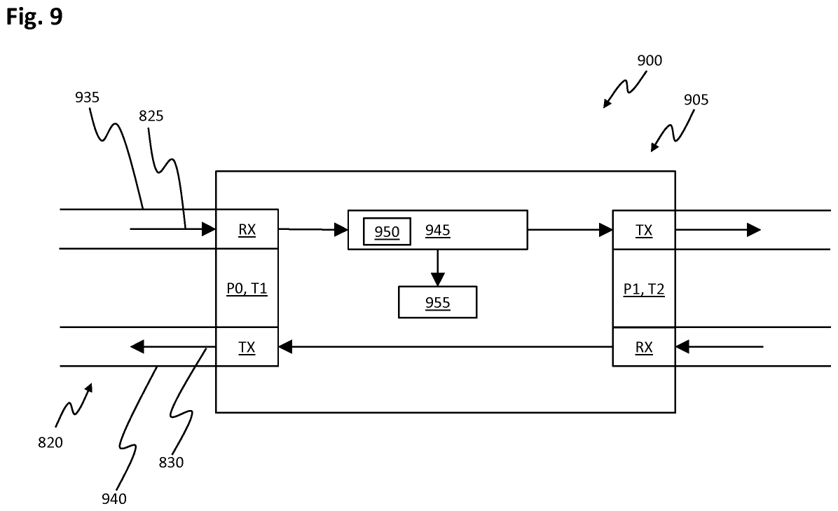

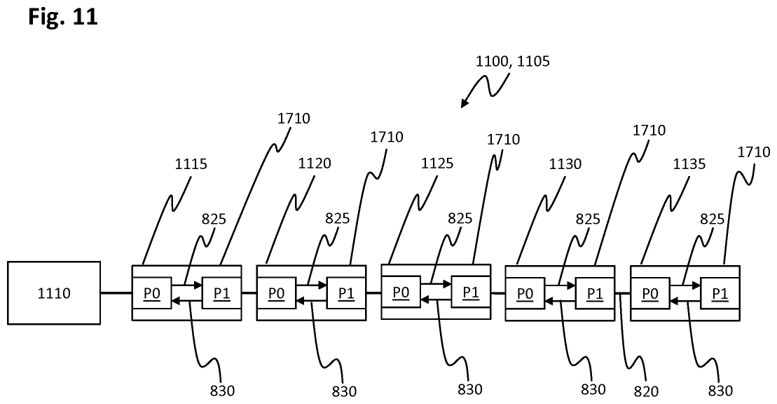

FIGS. 1, 8, 9, and 11 are described together in the following. FIG. 1 shows a schematic depiction of a method 100 for determining a set-up sequence of bus subscribers 1115, 1120, 1125, 1130, 1135 of an automation network 1100 according to a first embodiment. FIG. 8 shows a schematic depiction of a bus subscriber 800 for an automation network 1100 according to a first embodiment. FIG. 9 shows a schematic depiction of a bus subscriber structure according to a second embodiment 900 for, e.g., the automation network according to the first embodiment 1100, and FIG. 11 shows a schematic depiction of the automation network 1100 according to the first embodiment.

The automation network according to the first embodiment 1100 in FIG. 11 comprises a plurality of bus subscribers of the automation network according to the first embodiment 1105, which are connected to one another via at least one data line 820. The data line 820 may be embodied as a physical cable. At least one bus subscriber of the plurality of bus subscribers of the automation network according to the first embodiment 1105 is embodied as a main device, i.e., as a control bus subscriber of the automation network according to the first embodiment 1110 for controlling and coordinating subordinate devices, i.e., subordinate bus subscribers.

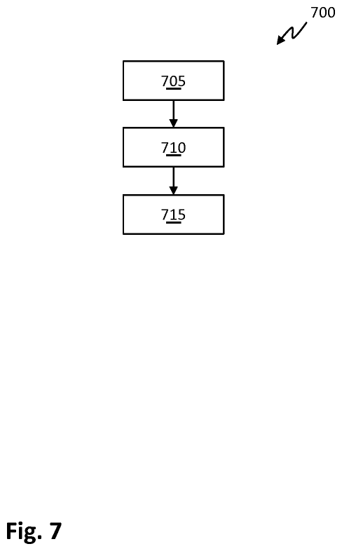

The control bus subscriber of the automation network according to the first embodiment 1110 is embodied to carry out a method 100 for determining a set-up sequence of a plurality of bus subscribers 1105 of the automation network 1100 according to the first embodiment according to the features of the following figures and/or a method 700 for controlling the plurality of bus subscribers 1105 of the automation network 1100 according to the first embodiment according to FIG. 7.

The automation network 1100 according to the first embodiment in FIG. 11 comprises, in addition to the first control bus subscriber 1110, a first first to first fifth bus subscriber 1115, 1120, 1125, 1130, 1135.

The first first to first fifth bus subscribers 1115, 1120, 1125, 1130, 1135 may also be referred to as the first to fifth bus subscribers 1115, 1120, 1125, 1130, 1135. The first first to first fifth bus subscribers 1115, 1120, 1125, 1130, 1135 may comprise a structure in accordance with the bus subscriber according to the first embodiment 800 of FIG. 8 and a structure in accordance with the bus subscriber according to the second embodiment 900 of FIG. 9. The first first to first fifth bus subscribers 1115, 1120, 1125, 1130, 1135 are each embodied as subordinate devices, i.e., as subordinate bus subscribers that may be controlled by the first control bus subscriber 1110. FIG. 11 thus shows the first embodiment of the automation network 1100 in which the first plurality of bus subscribers 1105 are each embodied as individually arranged first first to first fifth bus subscribers 1115, 1120, 1125, 1130, 1135.

If the first first to first fifth bus subscribers 1115, 1120, 1125, 1130, 1135 in FIG. 11 each comprise the structure of the bus subscriber according to the first embodiment 800 according to FIG. 8, then the first first to first fifth bus subscribers 1115, 1120, 1125, 1130, 1135 as bus subscribers according to the first embodiment 800 each comprise a first plurality of input/output ports 805. A first input/output port P0 and a second input/output port P1 of the first plurality of input/output ports 805 are each connected to at least one data line 820. A data packet may thus be received via the first input/output port P0 of the bus subscriber according to the first embodiment 800, e.g., the first first bus subscriber 1115 in FIG. 11, via the at least one data line 820 on a forward path 825.

Furthermore, the data packet may be output via the second input/output port P1 of the bus subscriber according to the first embodiment 800, e.g., the first first bus subscriber 1115 in FIG. 11, via the data line 820 on the forward path 825 to a further bus subscriber, for example the first second bus subscriber 1120 in FIG. 11. The bus subscriber according to the first embodiment 800, e.g., the first first bus subscriber 1115 in FIG. 11, is embodied to detect a first timestamp T1 upon receiving the data packet via the first input/output port P0 of the bus subscriber according to the first embodiment 800. The first timestamp T1 of the bus subscriber according to the first embodiment 800, i.e., the first first bus subscriber 1115, is embodied to assign a unique point in time to the receipt of the data packet on the forward path 825 via the first input/output port P0 of the bus subscriber 800 according to the first embodiment 800, i.e., the first first bus subscriber 1115, as an event.

The bus subscriber 800 according to the first embodiment 800, i.e., the first first bus subscriber 1115 of the automation network according to the first embodiment 1100, is embodied to record a second timestamp T2 upon receiving the data packet via the second input/output port P1 via the data line 820 on the return path of the data packet. The second timestamp T2 of the bus subscriber 800 according to the first embodiment 800, i.e., the first first bus subscriber 1115, is embodied to assign a unique time to the receipt of the data packet on a return path 830 via the second input/output port P1 of the bus subscriber according to the first embodiment 800 as an event. The bus subscriber according to the first embodiment 800, e.g., the first first bus subscriber 1115 in FIG. 11, is embodied to output the data packet on the return path 830 via the first input/output port P0 via the at least one data line 820 for the first control bus subscriber 1110 in FIG. 11.

The data packet is received via the first input/output port P0 of the bus subscriber according to the first embodiment 800 in FIG. 8 on the forward path 825 with the aid of a receiving unit RX. The receiving unit RX may form a so-called receiver and be embodied to receive the data packet via the data line 820. It is understood that each of the first plurality of input/output ports 805 of the bus subscriber according to the first embodiment 800 comprises a receiving unit RX for receiving the data packet. The transmission of the data packet via the second input/output port P1 of the bus subscriber according to the first embodiment 800 in FIG. 8 on the forward path 825 is carried out with the aid of a transmission unit TX. The transmission unit TX may form a so-called transceiver and be embodied to transmit the data packet via the data line 820.

It is understood that each of the first plurality of input/output ports 805 of the bus subscriber according to the first embodiment 800 comprises a transmission unit TX for transmitting the data packet. The receiving unit RX and the transmitting unit TX of an input/output port of a bus subscriber according to the first embodiment 800 are shown in FIG. 8 for the first to fifth bus subscribers 1115, 1120, 1125, 1130, 1135 of FIG. 11. This was done solely for reasons of clarity and is therefore not a limitation.

However, before the first first bus subscriber 1115 in FIG. 11 receives the data packet via the second input/output port P1 of the first first bus subscriber 1115 on the return path 830, the first first bus subscriber 1115 would output the data packet to the first second bus subscriber 1120 via the second input/output port P1 of the first first bus subscriber 1115 via the data line 820 on the forward path 825. The first second bus subscriber 1120 would then proceed in the same way as described above, i.e., upon receiving the data packet via the first input/output port P0 of the first second bus subscriber 1120 via the data line 820 on the forward path 825, it would record the first timestamp T1 and output the data packet via the second input/output port P1 of the first second bus subscriber 1120 via the data line 820 on the forward path 825 to the first third bus subscriber 1125.

The first third bus subscriber 1125 would also detect the first timestamp T1 upon receiving the data packet via the first input/output port P0 of the first third bus subscriber 1125 via the data line 820 on the forward path 825 and output the data packet via the second input/output port P1 of the first third bus subscriber 1125 via the data line 820 on the forward path 825 to the first fourth bus subscriber 1130. The first fourth bus subscriber 1130 would also detect the first timestamp T1 upon receipt of the data packet via the first input/output port P0 of the first fourth bus subscriber 1130 via the data line 820 on the forward path 825 and output the data packet via the second input/output port P1 of the first fourth bus subscriber 1130 via the data line 820 on the forward path 825 to the first fifth bus subscriber 1135.

Since the first fifth bus subscriber 1135 is the last bus subscriber in the series and no further bus subscriber is connected to the second input/output port P1 of the first fifth bus subscriber 1135 via the data line 820, the first fifth bus subscriber 1135 would, upon receiving the data packet via the first input/output port P0 of the first fifth bus subscriber 1135 via the data line 820 on the forward path 825, detect the first timestamp T1 and output the data packet via the first input/output port P0 via the data line 820 on the return path 830 to the first fourth bus subscriber 1130.

The first fourth bus subscriber 1130 would, upon receiving the data packet via the second input/output port P1 via the data line 820 on the return path 830, detect the second timestamp T2 and output the data packet via the first input/output port P0 of the first fourth bus subscriber 1130 via the data line 820 on the return path 830 to the first third bus subscriber 1125. Upon receiving the data packet via the second input/output port P1 via the data line 820 on the return path 830, the first third bus subscriber would detect the second timestamp T2 and output the data packet via the first input/output port P0 of the first third bus subscriber 1125 via the data line 820 on the return path 830 to the first second bus subscriber 1120.

Upon receiving the data packet via the second input/output port P1, the first second bus subscriber 1120 would detect the second timestamp T2 via the second input/output port P1 via the data line 820 on the return path 830 and output the data packet via the first input/output port P0 of the first second bus subscriber 1120 via the data line 820 on the return path 830 to the first first bus subscriber 1115.

It goes without saying that if the bus subscribers of the automation network are arranged differently according to the first embodiment 1100 in FIG. 11, i.e., if, for example, no first third bus subscriber 1125 is connected via the data line 820 to the second input/output port P1 of the first second bus subscriber 1120, the data packet is output from the first second bus subscriber 1120 directly after the first timestamp T1 is detected via the first input/output port P0 via the data line 820 on the return path 830 to the first first bus subscriber 1115. The arrangement of the first first to first fifth bus subscribers 1115, 1120, 1125, 1130, 1135 in FIG. 11 is therefore exemplary in nature.

The first timestamp T1 and the second timestamp T2 may each be detected on the basis of a clock functionality of a bus subscriber according to the first embodiment 800 or a bus subscriber according to the second embodiment 900. This will be described in more detail in the following. The bus subscriber according to the second embodiment 900 in FIG. 9 may have a second plurality of input/output ports 905 similar to the bus subscriber according to the first embodiment 800 in FIG. 8. The bus subscriber according to the second embodiment 900 in FIG. 9 may differ, for example, in a processing unit 945 from the bus subscriber according to the first embodiment 800 in FIG. 8. The processing unit 945 of the bus subscriber according to the second embodiment 900 is connected to a second forward data line 935 on the forward path 825 of the data packet, provided that the bus subscriber according to the second embodiment 900 comprises the first arrangement 1710.

Otherwise, i.e., if the second arrangement 1720 of the bus subscriber according to the second embodiment 900 is present, the processing unit 945 is connected to the second return data line 940 on the return path 830 of the data packet. The second forward data line 935 and the second return data line 940 form separate data lines, i.e., separate physical cables. If the processing unit 945 of the bus subscriber according to the second embodiment 900 is traversed by the data packet on the return path 830 via the second return data line 940, the data packet is processed on the return path 830, in contrast to the processing unit 945 processing the data packet on the forward path 825 via the second forward data line 935—provided that the bus subscriber according to the second embodiment 900 is addressed to read data from the data packet and/or write data to the data packet.

The bus subscriber according to the second embodiment 900 is further embodied to detect the first timestamp T1 upon receiving a data packet via the first input/output port P0 and the second forward data line 935 on the forward path 825 of the data packet and to forward the data packet via the second forward data line 935 to the processing unit 945, as is the case, for example, with the first bus subscriber 1115 of the automation network according to the first embodiment 1100 in FIG. 11. The processing unit 945 of the bus subscriber according to the second embodiment 900 is embodied to process the data packet in passing, i.e., in parallel with the ongoing receipt of the data packet via the first input/output port P0, and for forwarding the data packet via the second forward data line 935 to the second input/output port P1 of the bus subscriber according to the second embodiment 900. The bus subscriber according to the second embodiment 900 is embodied to output the data packet via the second input/output port P1 via the second outgoing data line 935 on the outgoing path 825 to another bus subscriber connected via the second input/output port P1, for example to the first second bus subscriber 1120 in FIG. 11.

The bus subscriber according to the second embodiment 900, i.e., for example, the first first bus subscriber 1115 in FIG. 11, is configured, upon receiving the data packet via the second input/output port P1 and the second return data line 940 on the return path 830, to detect the second timestamp T2 and to output the data packet via the first input/output port P0 and the second return data line 940 on the return path 830 to the first control bus subscriber 1110. The interaction of the structure of the bus subscriber according to the second embodiment 900 with the automation network according to the first embodiment 1100 in FIG. 11 results in a similar scenario with regard to the detection of the first and second timestamps T1, T2 of the first first to first fifth bus subscribers 1115, 1120, 1125, 1130, 1135 as described above in connection with the structure of the bus subscriber according to the first embodiment 800 in FIG. 8.

The processing unit 945 of the bus subscriber according to the second embodiment 900 in FIG. 9 is preferably embodied as an EtherCAT SubDevice Controller, provided that the bus subscriber according to the second embodiment 900 or the first first to first fifth bus subscribers 1115, 1120, 1125, 1130, 1135 in FIG. 11 are embodied for communication using the EtherCAT transmission protocol.

The processing unit 945 of the bus subscriber according to the second embodiment 900 may, for example, have the hardware-implemented local clock 950, e.g., with a circumference of 64 bits and a resolution of 1 bit=1 ns, in order to be able to detect the first and second timestamps T1, T2. However, the hardware-implemented local clock 950 is only shown schematically in FIG. 9. It is understood that bus subscribers in subsequent figures may also comprise a processing unit comprising the hardware-implemented local clock 950. If the processing unit 945 is an ESC as mentioned above, the ESC comprises the local clock 950.

However, for reasons of clarity, the first and second timestamps T1 and T2 are shown in FIG. 8.

It goes without saying that if the first to fifth bus subscribers 1115, 1120, 1125, 1130, 1135 in FIG. 11 comprise the structure of the bus subscriber according to the second embodiment 900 according to FIG. 9, the data line 820 in FIG. 11 may then also comprise a separate second forward data line 935 and a separate second return data line 940 according to FIG. 9.

The bus subscriber according to the second embodiment 900 may comprise a memory unit 955, in particular a register unit, which may be accessed by the processing unit 945 of the bus subscriber 900. It is also conceivable that the processing unit 945 of the bus subscriber according to the second embodiment 900 alternatively comprises the memory unit itself. The first and second timestamps T1, T2 may each be stored in the memory unit 955, in particular the register unit, of a bus subscriber according to the first embodiment 800 or a bus subscriber according to the second embodiment 900.

The first control bus subscriber 1110 may, for example, read out the memory unit 955 of a bus subscriber according to the first embodiment 800 or a bus subscriber according to the second embodiment 900 by sending a further data packet in order to obtain the recorded first and second timestamps T1, T2 and, based on this, to be able to carry out a seventh step 135 of the method according to the first embodiment 100, which will be described in the following, for determining the set-up sequence of the bus subscribers 1115, 1120, 1125, 1130, 1135 of the automation network according to the first embodiment 1100.

The method according to the first embodiment 100 in FIG. 1 comprises, in a first step 105 of the method according to the first embodiment, providing a data packet for the first plurality of bus subscribers 1105 of the automation network according to the first embodiment 1100. This is done, for example, by the first control bus subscriber 1105. A second step 110 of the method according to the first embodiment 100 comprises receiving the data packet on the forward path 825 via a first input/output port P0 of a bus subscriber according to the first embodiment 800 or according to the second embodiment 900, i.e., the first first to first fifth bus subscribers 1115, 1120, 1125, 1130, 1135 of the automation network according to the first embodiment 1100, and detecting a first timestamp T1 of the bus subscriber according to the first embodiment 800 or according to the second embodiment 900, i.e., the first first to first fifth bus subscribers 1115, 1120, 1125, 1130, 1135 of the automation network according to the first embodiment 1100.

In a third step 115 of the method according to the first embodiment 100, the data packet is output via a second input/output port P1 of the bus subscriber according to the first embodiment 800 or according to the second embodiment 900, i.e., the first first to first fifth bus subscribers 1115, 1120, 1125, 1130, 1135 on a forward path 825 to a further bus subscriber. In a fourth step 120 of the method according to the first embodiment 100, the data packet is received on a forward path 825 via a first input/output port P0 of the further bus subscriber and a first timestamp T1 of the further bus subscriber is detected.

In an intermediate step 123 of the method according to the first embodiment 100, a check may be carried out to determine whether no other bus subscriber is connected to the second input/output port P1 of the other bus subscriber. The check may be carried out, for example, by reading port information of the other bus subscriber, wherein the processing unit of the other bus subscriber may, for example, manage the port information. If the check in intermediate step 123 reveals that a further bus subscriber is still connected to the second input/output port P1 of the further bus subscriber, n-branch in FIG. 1, the method according to the first embodiment 100 returns to the above-mentioned third step 115 of the method according to the first embodiment 100.

If the check in intermediate step 123 of the method according to the first embodiment 100, which may also be referred to as branch 123, reveals that no further bus subscriber is connected to the second input/output port P1 of the further bus subscriber, j branch in FIG. 1, a fifth step 125 of the method according to the first embodiment 100 is carried out. It is understood that between the second and third steps 110, 115 of the method according to the first embodiment 100 in FIG. 1, a further branch may be inserted to determine whether no further bus subscriber is connected to the second input/output port of the bus subscriber, similar to branch 123 of the method according to the first embodiment 100.

The fifth step 125 of the method according to the first embodiment 100 comprises receiving the data packet on a return path 830 via the second input/output port P1 of the bus subscriber according to the first embodiment 800 or according to the second embodiment 900, i.e., the first first to first fifth bus subscribers 1115, 1120, 1125, 1130, 1135 via the at least one data line 820 and detecting a second timestamp T2 of the bus subscriber according to the first embodiment 800 or according to the second embodiment 900, i.e., the first first to first fifth bus subscribers 1115, 1120, 1125, 1130, 1135.

A sixth step 130 of the method according to the first embodiment 100 comprises outputting the data packet via the first input/output port P0 of the bus subscriber according to the first embodiment 800 or according to the second embodiment 900, i.e., the first first to first fifth bus subscribers 1115, 1120, 1125, 1130, 1135 on the return path 830. The first control bus subscriber 1110 may read out the first and second timestamps T1, T2 stored in the memory units 955 of the first first to first fifth bus subscribers 1115, 1120, 1125, 1130, 1135 before a seventh step 135 of the method according to the first embodiment 100 is performed.

Finally, the seventh step 135, which has already been indicated above, comprises correlating the first timestamp T1 and the second timestamp T2 of a bus subscriber according to the first embodiment 800 or according to the second embodiment 900, i.e., the first first to first fifth bus subscribers 1115, 1120, 1125, 1130, 1135, in order to determine the set-up sequence of the first plurality of bus subscribers 1105 based thereon.

If the processing sequence and the set-up sequence of the first first to first fifth bus subscribers 1115, 1120, 1125, 1130, 1135 match, the first first to first fifth bus subscribers 1115, 1120, 1125, 1130, 1135 have the first arrangement 1710. The receipt time or the second timestamp T2 of a data packet at the second input/output port P1 of a bus subscriber of the first first to first fifth bus subscribers 1115, 1120, 1125, 1130, 1135 is larger than the receipt time or the first timestamp T1 of a data packet at the first input/output port P0 of the first first to first fifth bus subscribers 1115, 1120, 1125, 1130, 1135.

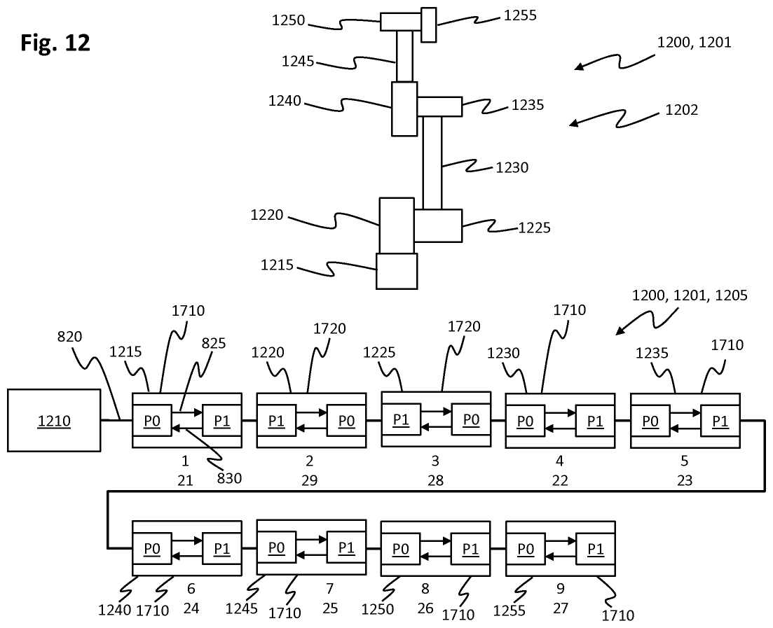

If the set-up sequence and processing sequence of the first first to first fifth bus subscribers 1115, 1120, 1125, 1130, 1135 differ from each other, the first first to first fifth bus subscribers 1115, 1120, 1125, 1130, 1135 each comprise the second arrangement 1720. The second arrangement 1720 is shown in FIG. 12. FIG. 11 shows the first arrangement 1710 for the first first to first fifth bus subscribers 1115, 1120, 1125, 1130, 1135. The receipt time or the second timestamp T2 of a data packet at the second input/output port P1 of a bus subscriber with the second arrangement according to the first embodiment 800 or according to the second embodiment 900, i.e., the first first to first fifth bus subscribers 1115, 1120, 1125, 1130, 1135, is smaller than the receipt time or the first timestamp T1 of a data packet at the first input/output port P0 of the bus subscriber according to the first embodiment 800 or according to the second embodiment 900, i.e., the first first to first fifth bus subscribers 1115, 1120, 1125, 1130, 1135.

If a bus subscriber generally does not comprise any other connected bus subscribers at the second input/output port P1 of the bus subscriber in the first arrangement, the second timestamp T2 of the bus subscriber is set equal to the first timestamp T1 of the bus subscriber, i.e., the second timestamp T2 corresponds to the first timestamp T1. It goes without saying that this also applies in a similar manner to the second arrangement of a bus subscriber.

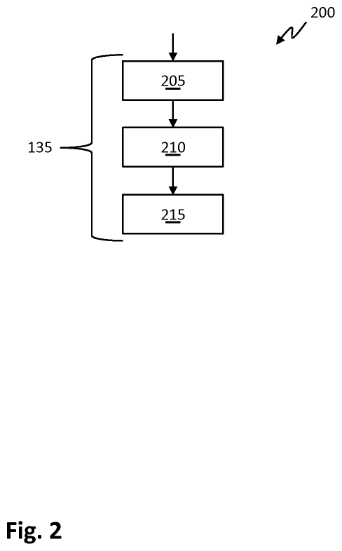

The relationship between the first and second timestamps T1 and T2 is described in more detail in the following with reference to FIG. 2.

It goes without saying that the method described in the first embodiment 100 may also be applied to the following figures, as well as to the structure of the bus subscriber according to the first embodiment 800 in FIG. 8, or the structure of the bus subscriber according to the second embodiment 900 in FIG. 9.

FIG. 2 shows a schematic depiction of a section 200 of the method according to the first embodiment 100 in FIG. 1, specifically a detailed depiction of the seventh step 135 of the method according to the first embodiment 100 in FIG. 1. The correlating in the seventh step 135 of the method according to the first embodiment 100 comprises, in a first intermediate step 205 in FIG. 2, calculating a difference between the second timestamp T2 for receiving the data packet via the second input/output port P1 and the first timestamp T1 for receiving the data packet via the first input/output port P0 of a bus subscriber according to the first embodiment 800 or according to the second embodiment 900, i.e., the first first to first fifth bus subscribers 1115, 1120, 1125, 1130, 1135.

In a second intermediate step 210 of section 200 in FIG. 2, the difference determined in the first intermediate step 205 of the seventh step 135 of the method according to the first embodiment 100 is evaluated by considering a sign of the difference. If the sign is positive, a bus subscriber with the structure according to the first embodiment 800 or the second embodiment 900, i.e., the first first to first fifth bus subscribers 1115, 1120, 1125, 1130, 1135, comprises the first arrangement 1710. If the sign is negative, a bus subscriber with the structure according to the first embodiment 800 or the second embodiment 900, i.e., the first first to first fifth bus subscribers 1115, 1120, 1125, 1130, 1135, comprises the second arrangement 1720.

A third intermediate step 215 in FIG. 2 for the seventh step 135 of the method according to the first embodiment 100 in FIG. 1 comprises that an amount of the determined difference per bus subscriber according to the first embodiment 800 or according to the second embodiment 900, i.e., the first first to first fifth bus subscribers 1115, 1120, 1125, 1130, 1135, is formed using a mathematical amount function, e.g., an absolute amount or via |x|=sqrt(x\hat{ }2), wherein x indicates the determined difference. The amounts formed in this way are sorted for the first plurality of bus subscribers 1105, e.g., sorted in ascending order (alternatively sorted in descending order), in order to determine the set-up sequence of the first plurality of bus subscribers 1105. The smaller the amount of the determined difference, the further away the respective bus subscriber is according to the first embodiment 800 or according to the second embodiment 900, i.e., the first first to first fifth bus subscribers 1115, 1120, 1125, 1130, 1135, are located further away from the bus subscriber providing the data packet, i.e., the first control bus subscriber 1110 in FIG. 11, in the first step 105 of the method according to the first embodiment 100.

In the example of FIG. 11, the signs of the difference between the second timestamp T2 and the first timestamp T1 of the first first to first fifth bus subscribers 1115, 1120, 1125, 1130, 1135 would be positive, so that as a result of applying the method according to the first embodiment 100, a match between the set-up sequence and the processing sequence of the first first to first fifth bus subscribers 1115, 1120, 1125, 1130, 1135 would be detectable. This means that the first first to first fifth bus subscribers 1115, 1120, 1125, 1130, 1135 each comprise the first arrangement 1710.

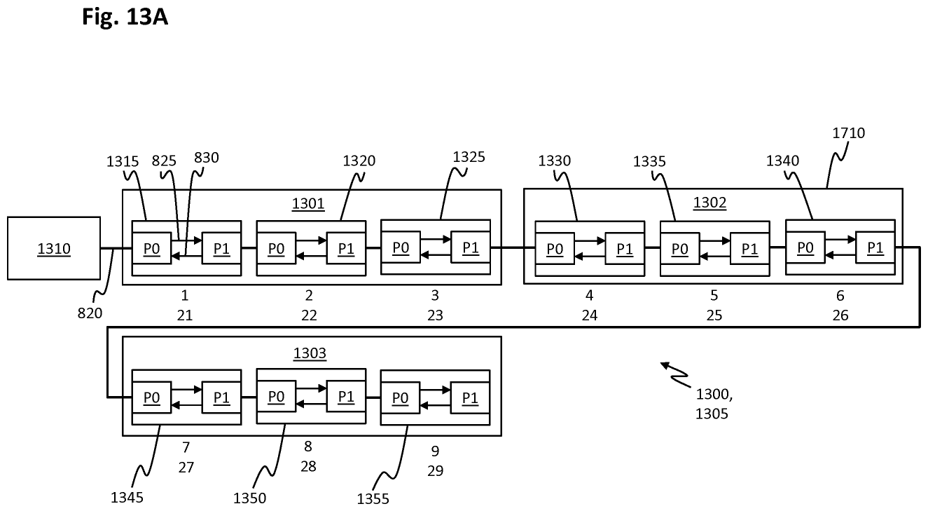

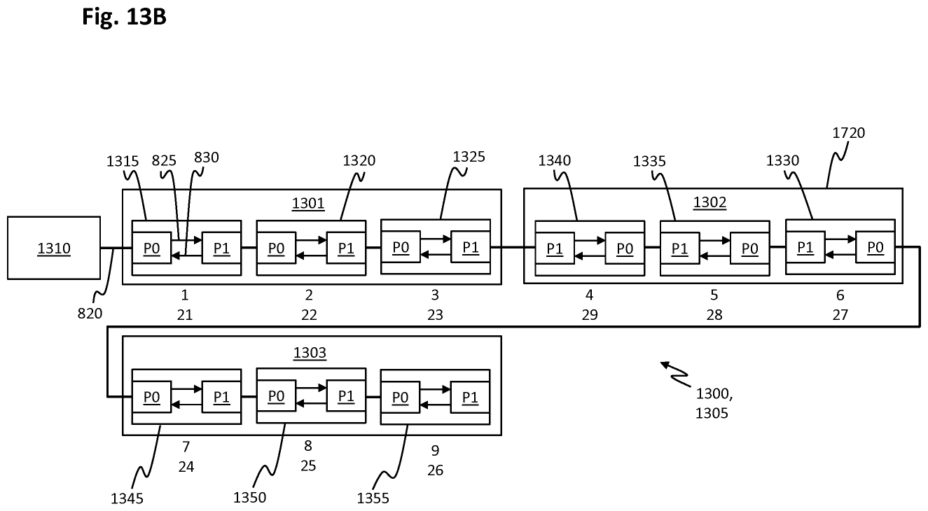

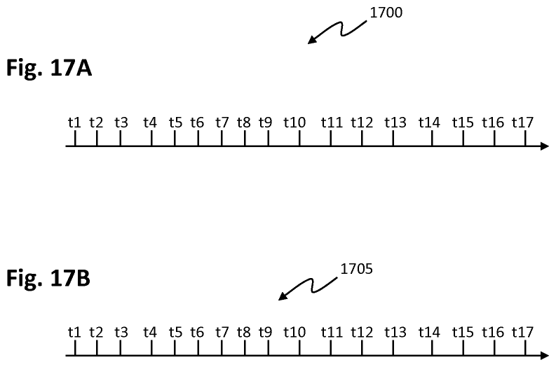

FIGS. 12, 13A, 13B, 17A, and 17B are described together in the following. FIG. 12 shows a schematic depiction of an automation network according to a second embodiment 1200. FIG. 13A shows a first schematic depiction of an automation network according to a third embodiment 1300, and FIG. 13B shows a second schematic depiction of the automation network according to the third embodiment 1300 in FIG. 13A. FIG. 17A shows a schematic depiction of a first timeline 1700 with timestamps for the automation network according to the second embodiment 1200 in FIG. 12, and FIG. 17B shows a schematic depiction of a second timeline 1705 with timestamps for the automation network according to the third embodiment 1300 in FIGS. 13A and 13B.

The automation network according to the second embodiment 1200 with the second plurality of bus subscribers 1205 in FIG. 12 is embodied as a second robot arm 1201 of an industrial robot, in contrast to the automation network according to the first embodiment 1100 in FIG. 11. The automation network 1200 according to the second embodiment in FIG. 12 has, in addition to the second control bus subscriber 1210, a second first to second ninth bus subscriber 1215, 1220, 1225, 1230, 1235, 1240, 1245, 1250, 1255. The second first to second ninth bus subscribers 1215, 1220, 1225, 1230, 1235, 1240, 1245, 1250, 1255 may also be referred to as the first to ninth bus subscribers 1215, 1220, 1225, 1230, 1235, 1240, 1245, 1250, 1255.

The second robot arm 1201 comprises a second plurality of movable axes 1202. The second plurality of movable axes 1202 of the second robot arm 1201 are each embodied as individual bus subscribers. Specifically, the second robot arm 1201 comprises a second first bus subscriber 1215, which is embodied, for example, as the base of the second robot arm 1201. A second second bus subscriber 1220 is embodied, for example, as a first axis. A second third bus subscriber 1225 is embodied, for example, as a second axis. A second fourth bus subscriber 1230 is embodied, for example, as a first connecting element.

A second fifth bus subscriber 1235 is embodied, for example, as a third axis. A second sixth bus subscriber 1240 is embodied, for example, as a fourth axis. A second seventh bus subscriber 1245 is embodied, for example, as a second connecting element. A second eighth bus subscriber 1250 is embodied, for example, as a fifth axis, and a second ninth bus subscriber 1255 is embodied, for example, as a sixth axis.

Furthermore, the automation network according to the second embodiment 1200 comprises a second control bus subscriber 1210, which is embodied to provide the data packet for the method for determining the set-up sequence according to the first embodiment 100 and the section 200 of the method according to the first embodiment 100 in FIG. 2. The sequence of events upon receipt of the data packet by the second plurality of bus subscribers 1205 in the context of the execution of the method according to the first embodiment 100 and its section 200 is similar to the above explanation, but with the difference that the second second bus subscriber 1220 and the second third bus subscriber 1225 in FIG. 12 each have the second arrangement 1720. This means that the second second bus subscriber 1220 and the second third bus subscriber 1225 receive the data packet via the data line 820 on the forward path via the second input/output port P1, respectively, instead of via the first input/output port P0 like the other second first and second fourth to second ninth bus subscribers 1215, 1230, 1235, 1240, 1245, 1250, 1255 in FIG. 12.

The first timeline 1700 in FIG. 17A for the automation network according to the second embodiment 1200 in FIG. 12 comprises first to seventeenth timestamps of the first timeline 1700 t1 to t17, which are broken down in more detail in the following Table 1:

TABLE 1
Timestamps of the first timeline

| | Bus subscribers of the automation |
|---|---|
| Timestamps of the | network according to the second |
| first timeline 1700 | embodiment 1200 (input/output port) |
| t1 | Second first bus subscriber 1215 |
| t2 | Second second bus subscriber 1220 |
| t3 | Second third bus subscriber 1225 |
| t4 | second fourth bus subscriber 1230 |
| t5 | Second fifth bus subscriber 1235 |
| t6 | Second sixth bus subscriber 1240 |
| t7 | Second seventh bus subscriber 1245 |
| t8 | Second eighth bus subscriber 1250 |
| t9 | Second ninth bus subscriber 1255 |
| t10 | Second eighth bus subscriber 1250 |
| t11 | Second seventh bus subscriber 1245 |
| t12 | second sixth bus subscriber 1240 |
| t13 | Second fifth bus subscriber 1235 |
| t14 | second fourth bus subscriber 1230 |
| t15 | Second third bus subscriber 1225 |
| t16 | Second second bus subscriber 1220 |
| t17 | Second first bus subscriber 1215 |

The timestamps of the first timeline 1700 are numbered consecutively in FIG. 17A for clarity. However, the first to seventeenth timestamps t1-t17 of the timeline 1700 are the above-mentioned first and second timestamps T1, T2, which are recorded by the second first to second ninth bus subscribers 1215, 1220, 1225, 1230, 1235, 1240, 1245, 1250, and 1255, respectively.

The timestamp of the first timeline 1700 t1 for the receipt of the data packet by the second first bus subscriber 1215 via its first input/output port P0 corresponds, for example, to the first timestamp T1 of the second first bus subscriber 1215. This is because the second first bus subscriber 1215 comprises the first arrangement 1710.

The timestamp of the first timeline 1700 t2 for the receipt of the data packet by the second second bus subscriber 1220 via its second input/output port P1 corresponds, for example, to the second timestamp T2 of the second second bus subscriber 1215. This is because the second second bus subscriber 1220 comprises the second arrangement 1720. The remaining third to seventeenth timestamps t3-t17 of the timeline according to the first embodiment 1700 may be assigned in a similar manner. However, this is not described in detail.

A processing order of the second plurality of bus subscribers 1205 in FIG. 12 would be: second first bus subscriber 1205, comprising the first position 21 in the processing order, second fourth bus subscriber 1230, comprising the second position 22 in the processing sequence, second fifth bus subscriber 1235, comprising the third position 23 in the processing sequence, second sixth bus subscriber 1240, comprising the fourth position 24 in the processing sequence, second seventh bus subscriber 1245, comprising the fifth position 25 in the processing sequence, second eighth bus subscriber 1250, comprising the sixth position 26 in the processing sequence, second ninth bus subscriber 1255, comprising the seventh position 27 in the processing sequence, second third bus subscriber 1225, comprising the eighth position 28 in the processing sequence, and second second bus subscriber 1220, comprising the ninth place 29 in the processing sequence.

When applying the first to third intermediate steps 205 to 215 of section 200 of the method according to the first embodiment 100, in order to carry out the seventh step 135 of the method according to the first embodiment 100, the second control bus subscriber 1210 in FIG. 12 would determine that the sign from t2-t16, i.e., the receipt time of the second input/output port P1 minus the receipt time of the first input/output port P0, is negative for the second second bus subscriber 1220, and that the sign from t3-t15 is negative for the second third bus subscriber 1225. This corresponds to the calculation based on the receipt time of the second input/output port P1, i.e., the second timestamp T2 of the corresponding bus subscriber minus the receipt time of the first input/output port P0, i.e., the first timestamp T1 of the corresponding bus subscriber. The sign of the difference may be used to determine the second arrangement 1720 of the second second and second third bus subscribers 1220, 1225 and the first arrangement 1710 for the remaining bus subscribers of the automation network according to the second embodiment 1200.

The first to ninth positions 1-9 in the set-up sequence of the second first to second ninth bus subscribers 1215, 1220, 1225, 1230, 1235, 1240, 1245, 1250, 1255, may be obtained by the second control bus subscriber 1210 by forming amounts of the differences from the timestamps t1-t17 of the first timeline 1700 or the timestamps T1, T2 of the aforementioned bus subscribers of the automation network according to the second embodiment 1200 and sorting the amounts. This corresponds to the third intermediate step 215 in FIG. 2. The larger the amount formed, the closer the respective second first to second ninth bus subscribers 1215, 1220, 1225, 1230, 1235, 1240, 1245, 1250, 1255. The second first to second ninth bus subscribers 1215, 1220, 1225, 1230, 1235, 1240, 1245, 1250, 1255 are arranged further away, the smaller the amount is.

The control program may recognize, based on the first to ninth position 21-29 of the processing sequence and the first to ninth position 1-9 of the set-up sequence of the second first to second ninth bus subscribers 1215, 1220, 1225, 1230, 1235, 1240, 1245, 1250, 1255, whether, for example, a movable axis must be turned to the right or left in order to carry out a predetermined movement of the robot in space.

It goes without saying that the data line 820 in FIG. 12 may also comprise a separate forward data line and a separate return data line.

FIGS. 13A and 13B show the automation network according to the third embodiment 1300 with the third plurality of bus subscribers 1305, which are grouped in the arrangement into third first to third third modules 1301, 1302, 1303, each comprising a plurality of bus subscribers. For example, the third first to third third modules 1301, 1302, 1303 each form tables, each comprising three bus subscribers per table. The third first to third third modules 1301, 1302, 1303 may also be referred to as the first to third modules 1301, 1302, 1303. FIG. 13A shows the first to ninth positions 1-9 in the set-up sequence of the third first to third ninth bus subscribers 1315, 1320, 1325, 1330, 1335, 1340, 1345, 1350, 1355 and the third control bus subscriber 1310. The third first to third ninth bus subscribers 1315, 1320, 1325, 1330, 1335, 1340, 1345, 1350, 1355 may also be referred to as the first to ninth bus subscribers 1315, 1320, 1325, 1330, 1335, 1340, 1345, 1350, 1355.

FIG. 13B shows a possible scenario in which the third second module 1302 comprises the second arrangement 1720, so that the third fourth to third sixth bus subscribers 1330, 1335, 1340 each comprise the second arrangement 1720 and each receive the data packet on the way there via the second input/output port P1. Accordingly, the first to ninth positions 21-29 of the processing sequence of the third first to third ninth bus subscribers 1315, 1320, 1325, 1330, 1335, 1340, 1345, 1350, 1355 via the third first module 1301, the third third module 1303 and finally the third second module 1302.

The descriptions in FIG. 12 therefore apply in a similar form to FIG. 13B.

The second timeline 1705 in FIG. 17B for the automation network according to the third embodiment 1300 in FIG. 13B comprises the first to seventeenth timestamps t1 to t17 of the second timeline 1705, which are broken down in more detail in the following Table 2:

TABLE 2
Timestamps of the second timeline

| | Bus subscribers of the automation network |
|---|---|
| Timestamps of the | according to the third embodiment 1300 |
| second timeline 1705 | (input/output port) |
| t1 | Third first bus subscriber 1315 |
| t2 | Third second bus subscriber 1320 |
| t3 | third third bus subscriber 1325 |
| t4 | third sixth bus subscriber 1340 |
| t5 | third fifth bus subscriber 1335 |
| t6 | third fourth bus subscriber 1330 |
| t7 | third seventh bus subscriber 1345 |
| t8 | third eighth bus subscriber 1350 |
| t9 | third ninth bus subscriber 1355 |
| t10 | third eighth bus subscriber 1350 |
| t11 | third seventh bus subscriber 1345 |
| t12 | third fourth bus subscriber 1330 |
| t13 | third fifth bus subscriber 1335 |
| t14 | third sixth bus subscriber 1340 |
| t15 | third third bus subscriber 1325 |
| t16 | third second bus subscriber 1320 |
| t17 | third first bus subscriber 1315 |

The description of the first to seventeenth timestamps t1 to t17 of the second timeline 1705 with regard to the first and second timestamps T1, T2 of a bus subscriber in connection with Table 1 applies analogously to Table 2. The data line 820 in FIGS. 13A and 13B may also comprise a separate forward data line and a separate return data line.

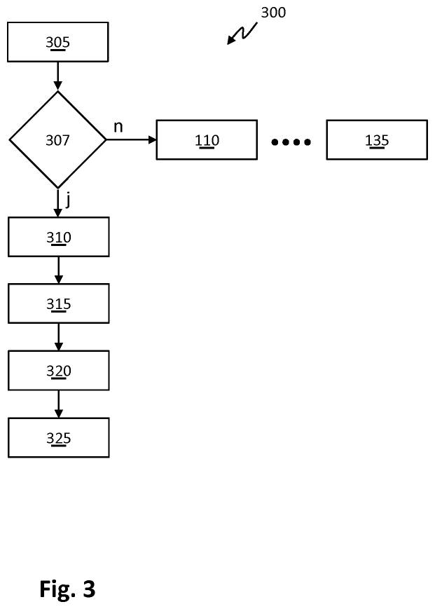

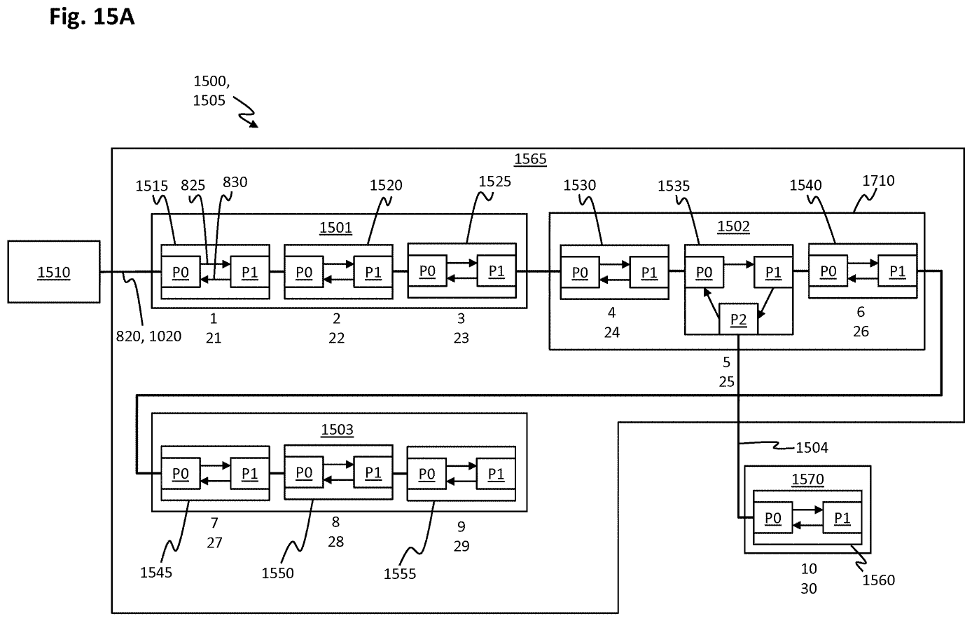

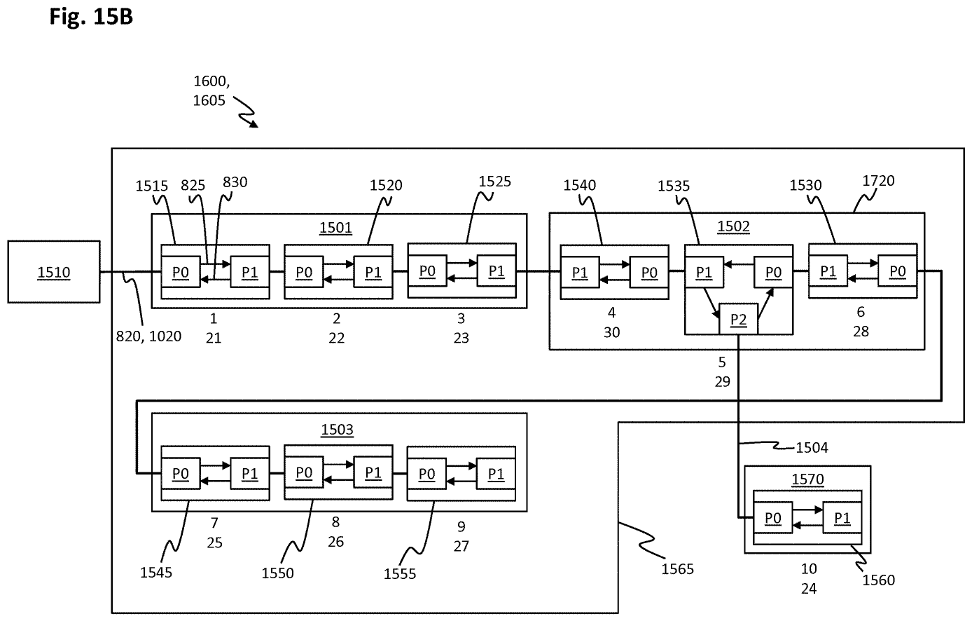

FIG. 3 and FIG. 15A are described together in the following. FIG. 3 shows a schematic depiction of a method for determining a set-up sequence of bus subscribers in an automation network according to a second embodiment 300, and FIG. 15A shows a schematic first depiction of an automation network according to a fifth embodiment 1500.

The automation network according to the fifth embodiment 1500 in FIG. 15A differs from the automation network according to the third embodiment in FIGS. 13A and 13B in that the fifth second module 1502 comprises a bus subscriber, for example, the fifth fifth bus subscriber 1535, which comprises three input/output ports P0, P1, P2, wherein a fifth tenth bus subscriber 1560 is connected to the third input/output port P2 of the fifth fifth bus subscriber 1535 via a further data line 1504.

The data line 820 and the further data line 1504 may each be embodied as a separate forward data line and a separate return data line. It goes without saying that the embodiment of the fifth fifth bus subscriber 1535 is exemplary and that the other fifth first to fifth fourth bus subscribers 1515, 1520, 1525, 1530, as well as the fifth sixth to fifth tenth bus subscribers 1540, 1545, 1550, 1555, 1560 may be embodied in the same way. Therefore, the method for determining the set-up sequence of bus subscribers in the automation network according to the second embodiment 300 may not only be applicable with respect to the fifth bus subscriber 1535. The bus subscribers of the previous figures may also comprise more than two input/output ports P0, P1.

The first to tenth positions 1 to 10 of the set-up sequence and the first to tenth places 21 to 30 of the processing sequence of the fifth first to fifth tenth bus subscribers 1515, 1520, 1525, 1530, 1535, 1540, 1545, 1550, 1555, 1560 vary in FIG. 15A compared to FIGS. 13A and 13B. The fifth first to fifth tenth bus subscribers 1515, 1520, 1525, 1530, 1535, 1540, 1545, 1550, 1555, 1560 may also be referred to as the first to tenth bus subscribers 1515, 1520, 1525, 1530, 1535, 1540, 1545, 1550, 1555, 1560.

The method for determining the set-up sequence of bus subscribers of the automation network according to the second embodiment 300 in FIG. 3 comprises, in a first step 305 of the method according to the second embodiment 300, providing the data packet, analogous to the first step 105 of the method according to the first embodiment 100. In an intermediate step 307 of the method according to the second embodiment 300 in FIG. 3, it is checked whether a third input/output port P2 is present at the respective bus subscriber, for example the fifth bus subscriber 1535 in FIG. 15A. This may be done in a manner similar to the description of branch 123 of the method according to the first embodiment 100 in FIG. 1. If no third input/output port P2 is present on the bus subscriber, n branch of branch 307 of the method according to the second embodiment 300, the method according to the second embodiment 300 in FIG. 3 leads to the second to seventh method steps 110 to 135 of the method according to the first embodiment 100 in FIG. 1.

If, on the other hand, the bus subscriber comprises a third input/output port P2, j-branch of branch 307 of the method according to the second embodiment 300, the fifth control bus subscriber 1510 may, for example, divide the bus subscribers into a fifth first line 1565 and a fifth second line 1570 in a second step 310 of the method according to the second embodiment 300. The fifth first line 1565 may comprise all fifth first to fifth ninth bus subscribers 1515, 1520, 1525, 1530, 1535, 1540, 1545, 1550, 1555 in FIG. 15A. The fifth second line 1570 may form the fifth tenth bus subscriber 1560, which is connected to the third input/output port P2 of the fifth fifth bus subscriber 1535. The fifth first line 1565 may also be referred to as the first line 1565, and the fifth second line 1570 may also be referred to as the second line 1570.

In a third step 315 of the method according to the second embodiment 300, first the first timestamps T1 of the bus subscribers on the forward path 825 and second the second timestamps T2 of the bus subscribers on the return path 830 of the fifth first line 1565 are recorded; for reasons of redundancy, this is not repeated for the above description. In a fourth step 320 of the method according to the second embodiment 300 in FIG. 3, for the data packet on the return path of the bus subscribers of the fifth first line 1565, specifically upon receipt of the data packet by the fifth fifth bus subscriber 1535 via the second input/output port P1 from the fifth sixth bus subscriber 1540, the second timestamp T2 is recorded for the fifth fifth bus subscriber 1535.

In addition, the data packet is output via the third input/output port P2 via the further data line 1504 to the fifth tenth bus subscriber 1560, so that the fifth tenth bus subscriber 1560 may detect the first timestamp T1 upon receipt of the data packet via the first input/output port P0 of the fifth tenth bus subscriber 1560. Since the fifth tenth bus subscriber 1560 comprises no further bus subscribers connected to the second input/output port P1, the fifth tenth bus subscriber 1560 sends the data packet directly back to the fifth fifth bus subscriber 1535.

The fifth fifth bus subscriber 1535, for example, receives the data packet in a fifth step 325 of the method according to the second embodiment 300 via the third input/output port P2 and detects a third timestamp T3 of the fifth fifth bus subscriber 1535. Although the third timestamp T3 of the fifth fifth bus subscriber is detected, it is not taken into account in the seventh step 135 of the method according to the first embodiment 100 in FIG. 1 or in the first to third intermediate steps 205 to 215 of the section 200 of the seventh step 135 of the method according to the first embodiment 100 in FIG. 2.

The fifth fifth bus subscriber 1535 transmits the data packet to the fifth fourth bus subscriber 1530 on the return path 830 following the recording of the third timestamp T3 of the fifth fifth bus subscriber 1535 in the fifth step 325 of the method according to the second embodiment 300. It goes without saying that the fifth fourth to fifth first bus subscribers 1530, 1525, 1520, 1515 forward the data packet on the return path 830 to the fifth control bus subscriber 1510.

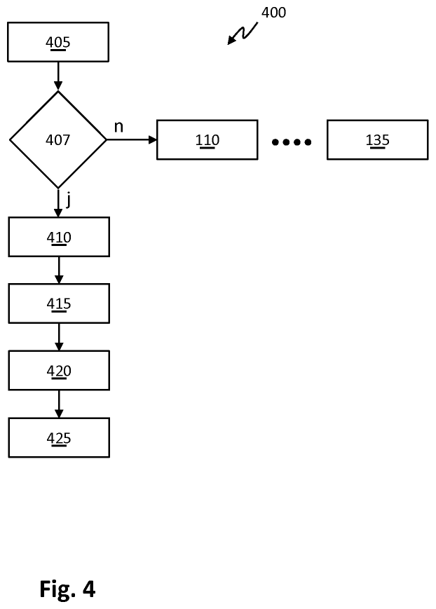

FIG. 4 and FIG. 15B are described together below. FIG. 4 shows a schematic depiction of a method for determining a set-up sequence of bus subscribers in an automation network according to a third embodiment 400, and FIG. 15B shows a schematic second depiction of the automation network according to the fifth embodiment 1500 in FIG. 15A. In contrast to FIG. 15A, the fifth second module 1502 in FIG. 15B comprises the second arrangement 1720. The method according to the third embodiment 400 in FIG. 4 differs from the method according to the third embodiment 300 in FIG. 3 in that, for example, the fifth fifth bus subscriber 1535 receives the data packet on the forward path 825 via the second input/output port P1 in a third step 415 of the method according to the third embodiment and records the first timestamp T1 of the fifth fifth bus subscriber 1535.

The data packet is then output via the third input/output port P2 via the fifth second line 1570 to the fifth tenth bus subscriber 1560, so that the fifth tenth bus subscriber 1560 may detect the first timestamp T1 of the fifth tenth bus subscriber 1560 when receiving the data packet via the first input/output port P0.

The fifth tenth bus subscriber 1560 comprises no further bus subscribers connected to the second input/output port P1. The second timestamp T2 of the fifth fifth bus subscriber 1560 then corresponds to the first timestamp T1 of the fifth fifth bus subscriber 1560, and the difference is calculated as described above.

A fourth step 420 of the method according to the third embodiment 400 in FIG. 4 differs from FIG. 3 in that, upon receipt of the data packet on the return path 830 via the fifth second line 1570 via the third input/output port P2 of the fifth fifth bus subscriber 1535, a third timestamp T3 is recorded by the fifth fifth bus subscriber 1535. Similar to FIG. 3, the third timestamp T3 is not taken into account in the seventh step 135 of the method according to the first embodiment 100 and its first to third intermediate steps 205, 210, 215 of the section 200 of the method according to the first embodiment 100 in FIG. 2. The fifth bus subscriber 1535 then outputs the data packet via the first input/output port P0 via the fifth first line 1565 on the forward path 825, in FIG. 1B, for example, to the fifth fourth bus subscriber 1530.

If the fifth fifth bus subscriber 1535 receives the data packet in a fifth step 425 of the method according to the third embodiment 400 in FIG. 4 via the first input/output port P0 on the return path 830 of the fifth first line 1565, the fifth fifth bus subscriber 1535 detects the second timestamp T2 of the fifth fifth bus subscriber 1535 and outputs the data packet via the second input/output port P1 on the return path 830 via the fifth first line 1565.

The first to eighteenth timestamps t1 to t18 of a first further timeline with reference to the explanation of the automation network according to the fifth embodiment 1500 of FIG. 15B are broken down in more detail in the following Table 3:

TABLE 3
Timestamp pf a first further machine

| | Bus subscribers of the automation |
|---|---|
| Timestamp of a first | network according to the fifth |
| further timeline | embodiment 1500 (input/output port) |
| t1 | Fifth first bus subscriber 1515 |
| t2 | Fifth second bus subscriber 1520 |
| t3 | Fifth third bus subscriber 1525 |
| t4 | Fifth sixth bus subscriber 1540 |
| t5 | Fifth fifth bus subscriber 1535 |
| t6 | Fifth tenth bus subscriber 1560 |
| t7 | Fifth fourth bus subscriber 1530 |
| t8 | Fifth seventh bus subscriber 1545 |
| t9 | Fifth eighth bus subscriber 1550 |
| t10 | Fifth ninth bus subscriber 1555 |
| t11 | Fifth eighth bus subscriber 1550 |
| t12 | Fifth seventh bus subscriber 1545 |
| t13 | Fifth fourth bus subscriber 1530 |
| t14 | Fifth fifth bus subscriber 1535 |
| t15 | Fifth sixth bus subscriber 1540 |
| t16 | Fifth third bus subscriber 1525 |
| t17 | Fifth second bus subscriber 1520 |
| t18 | Fifth first bus subscriber 1515 |

For the timestamps listed in Table 3 for the first additional timeline, the above description in Table 1 and Table 2 regarding the first and second timestamps T1 and T2 applies to the individual bus subscribers. In Table 3, the third timestamp T3 for the receipt of the data packet via the third input/output port P2 of the fifth bus subscriber 1535 is not listed, as it is not taken into account, as mentioned above, for the method according to the first embodiment 100 in FIG. 1 or the first to third intermediate steps 205-215 of section 200 of the seventh step 135 of the method according to the first embodiment 100 in FIG. 2.

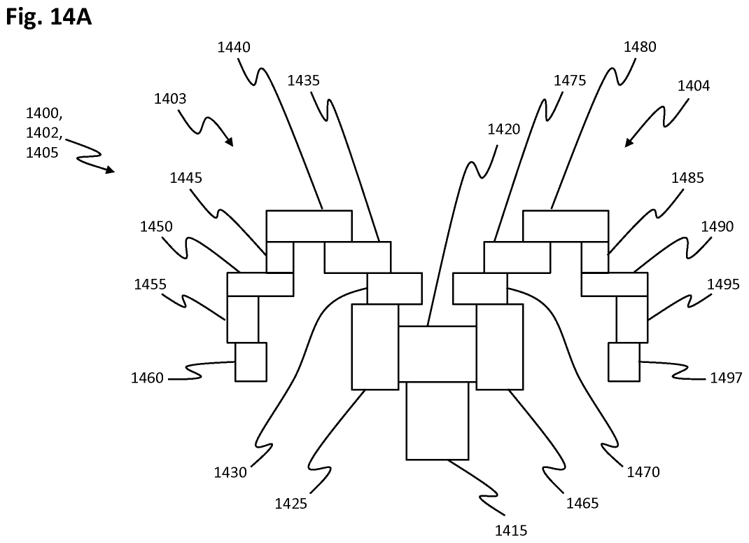

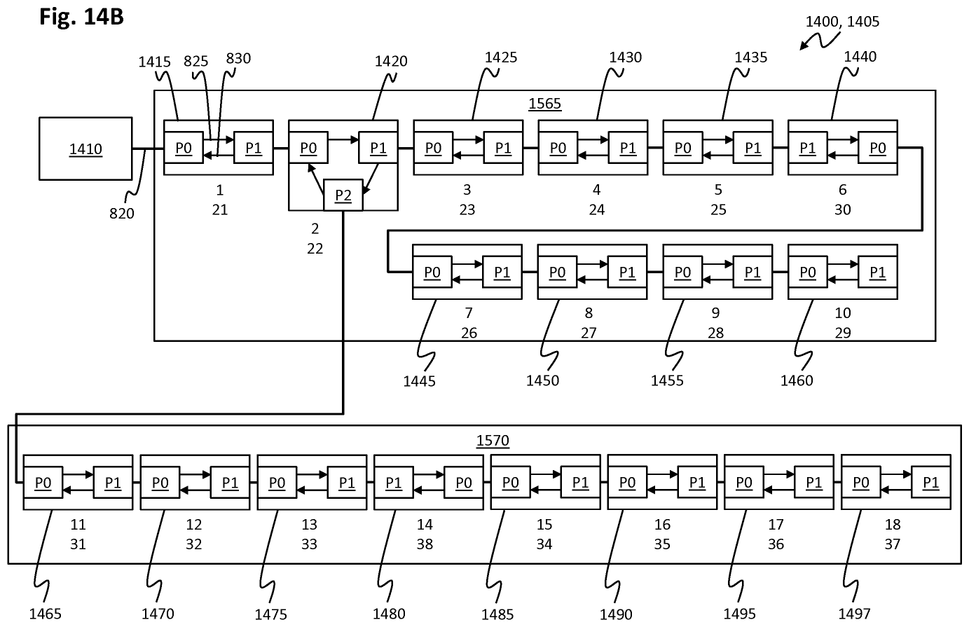

FIGS. 14A and 14B are described together in the following. FIG. 14A shows a first schematic depiction of an automation network according to a fourth embodiment 1400, and FIG. 14B shows a second schematic depiction of the automation network according to the fourth embodiment 1400. The automation network according to the fourth embodiment 1400 is in this context formed as a first and second robot arm 1403, 1404 of an industrial robot, wherein the plurality of movable axes 1402 of the fourth first and fourth second robot arms 1403, 1404 each represent the individual fourth first to fourth eighteenth bus subscribers 1415, 1420, 1425, 1430, 1435, 1440, 1445, 1450, 1455, 1460, 1465, 1470, 1475, 1480, 1485, 1490, 1495, 1497.

The fourth first to fourth eighteenth bus subscribers 1415, 1420, 1425, 1430, 1435, 1440, 1445, 1450, 1455, 1460, 1465, 1470, 1475, 1480, 1485, 1490, 1495, 1497 may also be used as the first to eighteenth bus subscribers 1415, 1420, 1425, 1430, 1435, 1440, 1445, 1450, 1455, 1460, 1465, 1470, 1475, 1480, 1485, 1490, 1495, 1497. The descriptions relating to the second robot arm 1201 as an automation network according to the second embodiment 1200 in FIG. 12 also apply without restriction to the fourth first and fourth second robot arms 1403, 1404 as automation networks according to the fourth embodiment 1400 in FIG. 14.

The fourth first bus subscriber 1415 may, for example, form the base/first axis of the fourth first and fourth second robot arms 1403, 1404. The fourth second bus subscriber 1420 may, for example, form a first connecting element that comprises a first to third input/output port P0, P1, P2, similar to the fifth fifth bus subscriber 1535 of the automation network according to the fifth embodiment 1500 in FIGS. 15A and 15B. A fourth third bus subscriber 1425 is arranged at the second input/output port P1 of the fourth second bus subscriber 1420.

The fourth third bus subscriber 1425 is embodied, for example, as a second axis of the fourth first robot arm 1403. The fourth fourth bus subscriber 1430 is embodied, for example, as a third axis of the fourth first robot arm 1403. The fourth fifth bus subscriber 1435 is embodied, for example, as a second connecting element of the fourth first robot arm 1403. The fourth sixth bus subscriber 1440 is embodied, for example, as a fourth axis of the fourth first robot arm 1403. The fourth seventh bus subscriber 1445 is embodied, for example, as a third connecting element of the fourth first robot arm 1403. The fourth eighth bus subscriber 1450 is embodied, for example, as a fifth axis of the fourth first robot arm 1403. The fourth ninth bus subscriber 1455 is embodied, for example, as a fourth connecting element, and the fourth tenth bus subscriber 1460 is embodied, for example, as a first gripper of the fourth first robot arm 1403. The aforementioned fourth first to fourth tenth bus subscribers 1415, 1420, 1425, 140, 1435, 1440, 1445, 1450, 1455, 1460 may form a fourth first line 1565. The fourth first line 1565 may also be referred to as a first line 1565.

A fourth eleventh bus subscriber 1465 of the fourth second robot arm 1404 may be connected via the third input/output port P2 of the fourth second bus subscriber 1420. The fourth eleventh bus subscriber 1465 may be embodied as a seventh axis. A fourth twelfth bus subscriber 1470 may, for example, form an eighth axis. A fourth thirteenth bus subscriber 1475 may, for example, form a fifth connecting element. A fourth fourteenth bus subscriber 1480 may, for example, form a ninth axis. A fourth fifteenth bus subscriber 1485 may, for example, form a sixth connecting element. A fourth sixteenth bus subscriber 1490 may, for example, form a tenth axis. A fourth seventeenth bus subscriber 1495 may, for example, form a seventh connecting element, and a fourth eighteenth bus subscriber 1497 may, for example, form a second gripper. The aforementioned fourth eleventh to fourth eighteenth bus subscribers 1465, 1470, 1475, 1480, 1485, 1490, 1495, 1497 may form the fourth second robot arm 1404 and form a fourth second line 1570 for the automation network 1400. The fourth second line 1570 may also be referred to as a second line 1570.

For example, the data packet from the fourth control bus subscriber 1410 of the automation network according to the fourth embodiment 1400 may first be output via the fourth first line 1565 and then via the fourth second line 1570. It goes without saying that this may also be done in reverse, or a separate data packet may be output per line. This also applies to other figures in which the bus subscribers are grouped into different lines.

In the depiction in FIG. 14, for example, the fourth sixth bus subscriber 1440 of the fourth first robot arm 1403 and the fourth fourteenth bus subscriber 1480 of the second robot arm 1404 each comprise the second arrangement 1720. This means that they each receive an incoming data packet on the forward path 825 via the second input/output port P1 instead of via the first input/output port P0. Therefore, the tenth position 30 in the processing sequence of the fourth sixth bus subscriber 1480 differs from the sixth position 6 in the set-up sequence of the fourth sixth bus subscriber 1480. Therefore, the eighteenth place 38 in the processing sequence of the fourth fourteenth bus subscriber 1480 also differs from the fourteenth place 14 in the set-up sequence of the fourth fourteenth bus subscriber 1480.

In the first arrangement 1710 of the fourth sixth bus subscriber 1440, the fourth sixth bus subscriber 1440 would have the consecutive sixth position 26 in the processing sequence, which would correspond to the sixth position 6 in the set-up sequence. Upon first arrangement 1710 of the fourth fourteenth bus subscriber 1480, the fourth fourteenth bus subscriber 1480 would have the sequential fourteenth position 34 in the processing sequence, which would correspond to the fourteenth position 14 in the set-up sequence.

Similar to FIG. 15B, the first to thirty-fifth timestamps t1 to t35 of a second further timeline may also be broken down in more detail for FIGS. 14A and 14B in the following Table 4:

TABLE 4
Timestamps of a section additional timeline

| | Bus subscribers of the automation network |
|---|---|
| Timestamps of a second | according to the fourth embodiment 1400 |
| additional timeline | (input/output port) |
| t1 | Fourth first bus subscriber 1415 |
| t2 | Fourth second bus subscriber 1420 |
| t3 | fourth third bus subscriber 1425 |
| t4 | fourth fourth bus subscriber 1435 |
| t5 | fourth fifth bus subscriber 1435 |
| t6 | fourth sixth bus subscriber 1440 |
| t7 | fourth seventh bus subscriber 1445 |
| t8 | fourth eighth bus subscriber 1450 |
| t9 | fourth ninth bus subscriber 1455 |
| t10 | fourth tenth bus subscriber 1460 |
| t11 | fourth ninth bus subscriber 1455 |
| t12 | fourth eighth bus subscriber 1450 |
| t13 | fourth seventh bus subscriber 1445 |
| t14 | fourth sixth bus subscriber 1440 |
| t15 | fourth fifth bus subscriber 1435 |
| t16 | fourth fourth bus subscriber 1430 |
| t17 | fourth third bus subscriber 1425 |
| t18 | fourth second bus subscriber 1420 |
| t19 | fourth eleventh bus subscriber 1465 |
| t20 | fourth twelfth bus subscriber 1470 |
| t21 | fourth thirteenth bus subscriber 1475 |
| t22 | fourth fourteenth bus subscriber 1480 |
| t23 | fourth fifteenth bus subscriber 1485 |
| t24 | fourth sixteenth bus subscriber 1490 |
| t25 | fourth seventeenth bus subscriber 1495 |
| t26 | fourth eighteenth bus subscriber 1497 |
| t27 | fourth seventeenth bus subscriber 1495 |
| t28 | fourth sixteenth bus subscriber 1490 |
| t29 | fourth fifteenth bus subscriber 1485 |
| t30 | fourth fourteenth bus subscriber 1480 |
| t31 | fourth thirteenth bus subscriber 1475 |
| t32 | fourth twelfth bus subscriber 1470 |
| t33 | fourth eleventh bus subscriber 1465 |
| t34 | fourth second bus subscriber 1420 |
| t35 | fourth first bus subscriber 1415 |

The descriptions for Table 3 also apply to Table 4, with the difference that Table 4 includes the third timestamp T3 for the third input/output port P2 of the fourth second bus subscriber 1420.

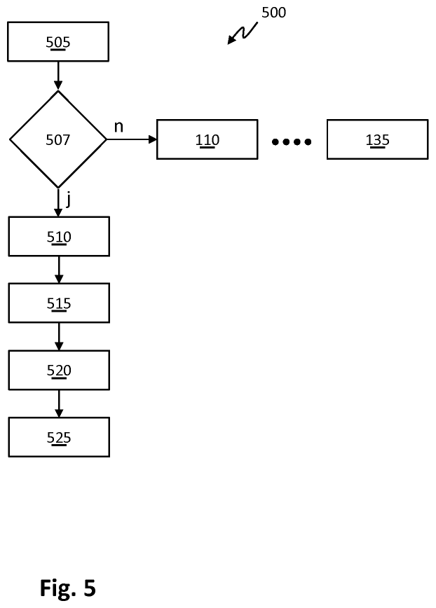

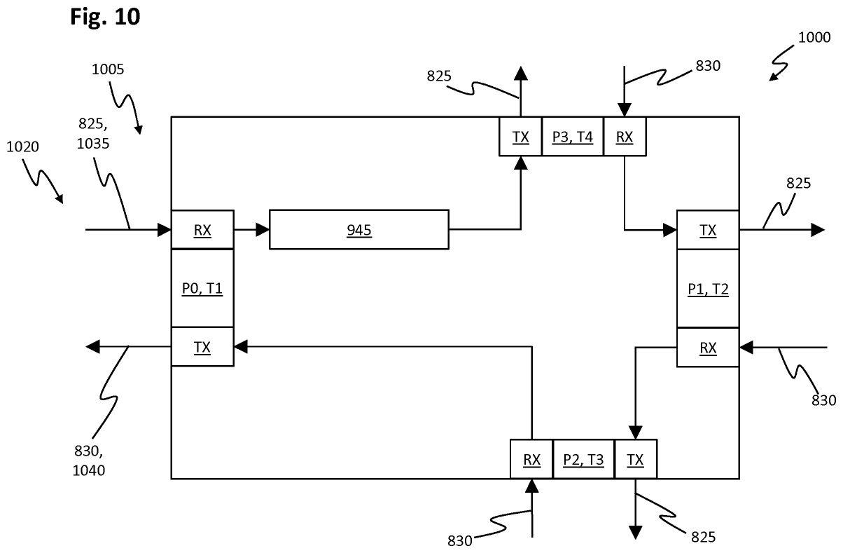

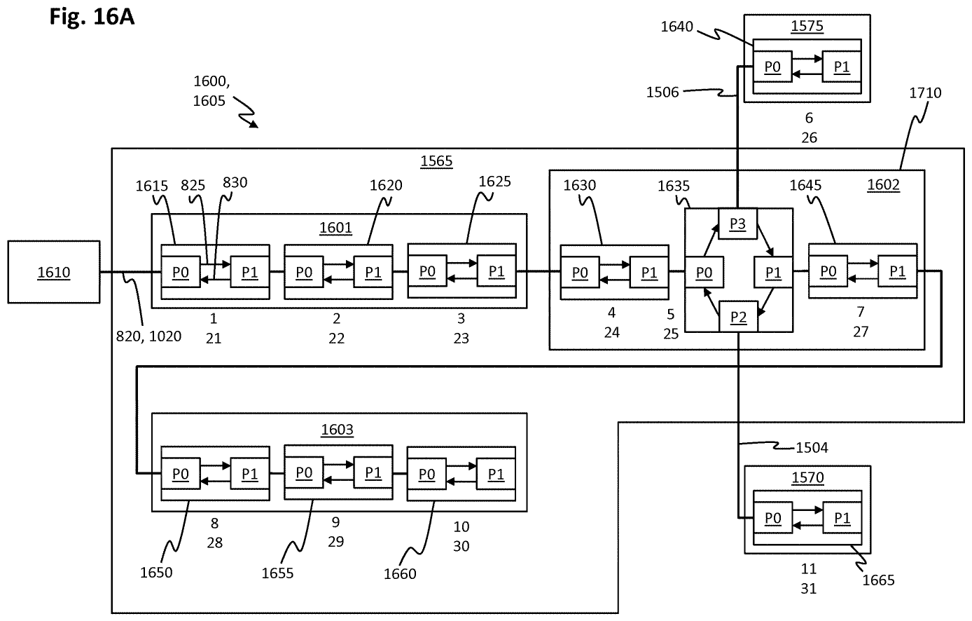

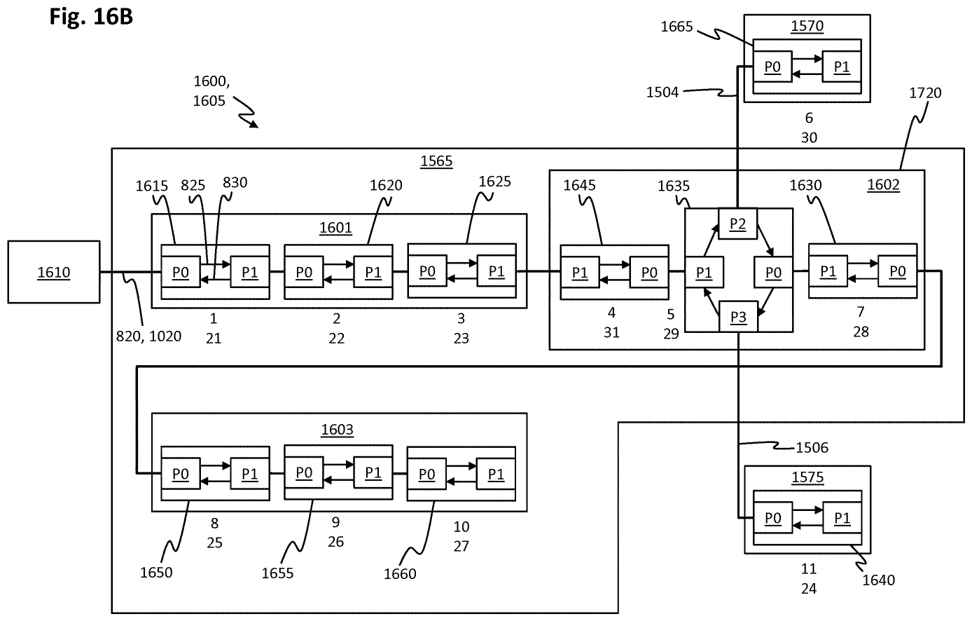

FIGS. 5, 10, and 16A are described together in the following. FIG. 5 shows a schematic depiction of a method for determining a set-up sequence of bus subscribers in an automation network according to a fourth embodiment 500. FIG. 10 shows a schematic depiction of a bus subscriber according to a third embodiment 1000, and FIG. 16A shows a schematic first depiction of an automation network according to a sixth embodiment 1600. The automation network according to the sixth embodiment 1600 in FIG. 16A comprises, in addition to the sixth control bus subscriber 1610, a sixth first to sixth eleventh bus subscriber 1615, 1620, 1625, 1630, 1635, 1640, 1645, 1650, 1655, 1660, 1665. The sixth first to sixth eleventh bus subscribers 1615, 1620, 1625, 1630, 1635, 1640, 1645, 1650, 1655, 1660, 1665 may also be referred to as the first to eleventh bus subscribers 1615, 1620, 1625, 1630, 1635, 1640, 1645, 1650, 1655, 1660, 1665.

The method according to the fourth embodiment 500 in FIG. 5 comprises, in a first step 505 of the method according to the fourth embodiment 500, providing the data packet, analogous to the first step 105 of the method according to the first embodiment 100. In an intermediate step 507 of the method according to the fourth embodiment 500 in FIG. 5, a check is made as to whether a third input/output port P2 and a fourth input/output port P3 are present at the respective bus subscriber, for example the sixth fifth bus subscriber 1635 of the automation network according to the sixth embodiment 1600 in FIG. 16A. This may be done in a similar manner to the description of branch 123 of the method according to the first embodiment 100 in FIG. 1.

If no third input/output port P2 and no fourth input/output port are provided on the bus subscriber, n branch of branch 507 of the method according to the fourth embodiment 500, the method according to the fourth embodiment 500 in FIG. 5 leads to the second to seventh method steps 110 to 135 of the method according to the first embodiment 100 in FIG. 1.

If, on the other hand, the bus subscriber comprises a third input/output port P2 and a fourth input/output port P3, j branch of branch 507 of the method according to the fourth embodiment 500, then, for example, the sixth control bus subscriber 1610 of the automation network according to the sixth embodiment 1600 may divide up the bus subscribers into a sixth first line 1565, a sixth second line 1570, and a sixth third line 1575 in a second step 510 of the method according to the fourth embodiment 500. The sixth first line 1565, the sixth second line 1570, and the sixth third line 1575 may also be referred to as the first line 1565, the second line 1570, and the third line 1575. The sixth fifth bus subscriber 1635 may output the data packet via the sixth third line 1575 on the forward path via the fourth input/output port P3 in the second step 510 of the method according to the fourth embodiment 500, so that a sixth sixth bus subscriber 1640 of the sixth third line 1575 may detect a first timestamp T1 of the sixth sixth bus subscriber 1640 on the forward path.

In FIG. 16A, the sixth first line 1565 may thereby comprise all sixth first to sixth fifth bus subscribers 1615, 1620, 1625, 1630, 1635 as well as all sixth seventh to sixth tenth bus subscribers 1645, 1650, 1655, 1660. The sixth second line 1570 may form the sixth eleventh bus subscriber 1665, which is connected to the third input/output port P2 of the sixth fifth bus subscriber 1635.

Since the sixth sixth bus subscriber 1640 comprises no further bus subscribers connected to the second input/output port P1, the sixth sixth bus subscriber 1640 sends the data packet directly back to the sixth fifth bus subscriber 1635 via the fourth input/output port P3 of the sixth fifth bus subscriber 1635.

The sixth fifth bus subscriber 1635 receives the data packet in a third step 515 of the method according to the fourth embodiment 500 via the fourth input/output port P3 and records a fourth timestamp T4 of the sixth fifth bus subscriber 1635. Finally, in the third step 515 of the method according to the fourth embodiment 500, the sixth fifth bus subscriber 1635 outputs the data packet to the sixth first line 1565 on the forward path 825 via the second input/output port P1 so that the sixth seventh to sixth tenth bus subscribers 1645, 1650, 1655, 1660 may each detect the first timestamp T1 of the respective bus subscriber on the forward path 825 and/or the second timestamp T2 of the respective bus subscriber on the return path 830.

If the sixth fifth bus subscriber 1635 receives the data packet via the second input/output port P1 in a fourth step 520 of the method according to the fourth embodiment 500 on the return path of the sixth first line 1565, the sixth fifth bus subscriber 1635 detects a second timestamp T2 of the sixth fifth bus subscriber 1635 and outputs the data packet via the third input/output port P2 on the forward path 825 to the sixth eleventh bus subscriber 1665 of the sixth second line 1570, so that the sixth eleventh bus subscriber 1665 may detect the first timestamp T1 of the sixth eleventh bus subscriber 1665 on the forward path 825.

If the sixth fifth bus subscriber 1635 receives the data packet via the third input/output port P2 on the return path 830 of the sixth second line 1570 in a fifth step 525 of the method according to the fourth embodiment 500, the sixth fifth bus subscriber 1635 detects a third timestamp T3 of the sixth fifth bus subscriber 1635 and outputs the data packet via the first input/output port P0 on the return path 830 via the sixth first line 1565 in the direction of the sixth control bus subscriber 1610. The sixth control bus subscriber 1610 may then, for example, output a further data packet in order to read out the first to fourth timestamps T1-T4 of the bus subscribers of the automation network according to the sixth embodiment 1600 and, based thereon, carry out the seventh step 135 of the method according to the first embodiment 100, including the first to third intermediate steps 205, 210, 215 of section 200 of the seventh step 135 of the method according to the first embodiment 100 in accordance with FIGS. 1 and 2.

It goes without saying that the data line 820 as well as the further data line 1504 and the second further data line 1506 may each comprise two separate data lines in order to separate the forward path 825 and the return path 830 for the data packet.

The sixth fifth bus subscriber 1635 in FIG. 16A may, for example, comprise the structure of the bus subscriber according to the third embodiment 1000 in FIG. 10. In this context, a third data line 1020 is split up into a third forward data line 1035 for the forward path 825 of the data packet and a third return data line 1040 for the return path 830 of the data packet. The third forward data line 1035 and the third return data line 1040 may also be referred to as the forward data line 1035 and the return data line 1040.

A processing unit 945 is arranged between the first input/output port P0 of the bus subscriber according to the third embodiment 1000 in FIG. 10 and the fourth input/output port P3 of the bus subscriber according to the third embodiment 1000, wherein the processing unit 945 may be embodied similarly to the bus subscriber according to the second embodiment 900 in FIG. 9. The processing unit 945 is connected to the forward data line 1035 of the bus subscriber according to the third embodiment 1000 on the forward path 825 of the data packet and is embodied to process the data packet in passing, i.e., in parallel to the continuous receipt of the data packet via the first input/output port P0. Furthermore, the processing unit 945 is embodied to forward the data packet via the third forward data line 1035 to the fourth input/output port P3 of the bus subscriber according to the third embodiment 1000.

If a bus subscriber comprises only three input/output ports instead of the four input/output ports P0, P1, P2, P3, the fourth input/output port P3 would not be present, for example, so that the processing unit would then be located between the first input/output port P0 and the second input/output port P1. The connection of the processing unit may be made by the forward data line 1035 of the bus subscriber according to the third embodiment 1000 between the aforementioned input/output ports in order to form the forward path 825 for the data packet.

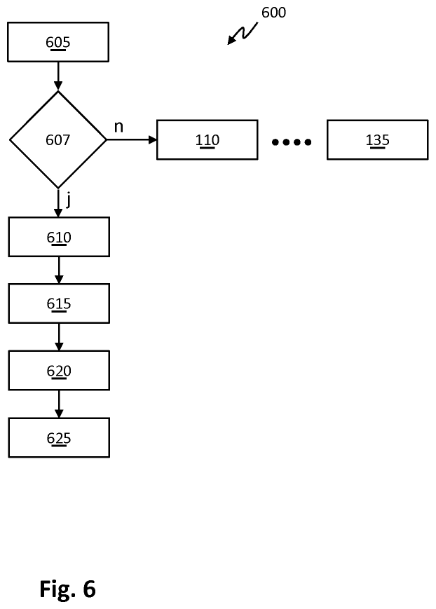

FIG. 6 and FIG. 16B are described together in the following. FIG. 6 shows a schematic depiction of a method for determining a set-up sequence according to a fifth embodiment 600. FIG. 16B shows a schematic second depiction of the automation network according to the sixth embodiment 1600 in FIG. 16A. Similar to FIG. 16A, the sixth plurality of bus subscribers 1605 in FIG. 16B are arranged in sixth first to third modules 1601, 1602, 1603 of the automation network according to the sixth embodiment 1600, with three or five bus subscribers respectively. The sixth first to third modules 1601, 1602, 1603 may also be referred to as first to third modules 1601, 1602, 1603. The sixth first to third modules 1601, 1602, 1603 each form tables. In contrast to FIG. 16A, however, the sixth second module 1602 in FIG. 16B has the second arrangement 1720.

The method according to the fifth embodiment 600 in FIG. 6 is similar to the method according to the fourth embodiment 500 in FIG. 5. A first step 605 of the method according to the fifth embodiment 600 and an intermediate step 607 of the method according to the fifth embodiment 600 in FIG. 6 may be similar to the first step 505 of the method according to the fourth embodiment 500 and the intermediate step 507 of the method according to the fourth embodiment 500 in FIG. 5, therefore reference is made to the above description.

A second step 610 of the method according to the fifth embodiment 600 in FIG. 6 may be similar to the second step 510 of the method according to the fourth embodiment 500 in FIG. 5 in that the sixth control bus subscriber 1610 may divide up the bus subscribers into a sixth first line 1565, a sixth second line 1570, and a sixth third line 1575, provided that, for example, the bus subscriber, in FIG. 16B the sixth fifth bus subscriber 1635, comprises a third input/output port P2 and a fourth input/output port P3. If, for example, the sixth fifth bus subscriber 1635 receives the data packet via the second input/output port P1, the sixth fifth bus subscriber 1635 records the first timestamp T1 of the sixth fifth bus subscriber 1635 and, in the second step 610 of the method according to the fifth embodiment 600, transmits the data packet via the third input/output port P2 via the sixth second line 1570 on the forward path 825 to the sixth eleventh bus subscriber 1665.

In the second arrangement 1720 of the sixth second module 1602, the second input/output port P1 corresponds to the input/output port of the sixth fifth bus subscriber 1635, which faces the preceding sixth seventh bus subscriber 1645 and via which the sixth fifth bus subscriber 1635 consequently receives a data packet on the forward path 825. The sixth eleventh bus subscriber 1665 may then record the first timestamp T1 of the sixth eleventh bus subscriber 1665 upon receipt of the data packet via the first input/output port P0 of the sixth eleventh bus subscriber 1665.

In a third step 615 of the method according to the fifth embodiment 600, the sixth fifth bus subscriber 1635 may detect the third timestamp T3 of the sixth fifth bus subscriber 1635 upon receiving the data packet on the return path of the second line 1570 via the third input/output port P2. Furthermore, in the third step 615 of the method according to the fifth embodiment 600, the sixth fifth bus subscriber 1635 may output the data packet via the first input/output port P0 via the first line 1565 on the forward path 825. In the second arrangement 1720 of the sixth fifth bus subscriber 1635, the first input/output port P0 is the input/output port facing the sixth fourth bus subscriber 1630 of the first line 1565. The bus subscribers of the first line 1565 may then each detect the first timestamps T1 of the bus subscribers on the forward path 825 of the data packet and/or the second timestamps T2 of the bus subscribers on the return path 830 of the data packet.

In a fourth step 620 of the method according to the fifth embodiment 600, the sixth fifth bus subscriber 1635 records the second timestamp T2 of the sixth fifth bus subscriber 1635 upon receiving the data packet via the first input/output port P0 on the return path 830 of the first line. Furthermore, in the fourth step 620 of the method according to the fifth embodiment 600, the sixth fifth bus subscriber 1635 transmits the data packet to the sixth sixth bus subscriber 1640 via the fourth input/output port on the forward path 825 of the third line 1575. The sixth sixth bus subscriber 1640 may then detect the first timestamp T1 of the sixth sixth bus subscriber 1640 upon receiving the data packet via the first input/output port and then output the data packet on the return path 830 of the third line 1575 to the sixth fifth bus subscriber 1635.

The sixth fifth bus subscriber 1635 receives the data packet in a fifth step 625 of the method according to the fifth embodiment 600 via the fourth input/output port P3 and thereby records a fourth timestamp T4 of the sixth fifth bus subscriber 1635. Finally, the sixth fifth bus subscriber 1635 outputs the data packet via the second input/output port P1 on the return path 830 to the first line 1565 in the direction of the sixth control bus subscriber 1610. The sixth control bus subscriber 1610 may then proceed in a manner similar to the above description in connection with FIGS. 5 and 16A, i.e., read out the recorded first to fourth timestamps T1-T4 of the sixth plurality of bus subscribers 1605 via a further data packet and, based on this, carry out the seventh step 135 of the method according to the first embodiment 100, including the first to third intermediate steps 205, 210, 215 of section 200 of the seventh step 135 of the method according to the first embodiment 100 in accordance with FIGS. 1 and 2.

It goes without saying that the sixth fifth bus subscriber 1635 in FIG. 16B may comprise a structure according to the bus subscriber according to the third embodiment 1000 in FIG. 10. For the sake of simplicity in the above explanation of FIGS. 6 and 16B, the presence of a processing unit of the plurality of bus subscribers 1605 of the automation network according to the sixth embodiment 1600 has not been taken into account. However, it goes without saying that the sixth plurality of bus subscribers 1605 may comprise these.

Similar to the above descriptions, the first to nineteenth timestamps t1 to t19 of a third further timeline may be broken down in more detail in the following Table 5:

TABLE 5
Timestamps of a third additional timeline

| | Bus subscribers of the automation network |
|---|---|
| Timestamps of a third | according to the sixth embodiment 1600 |
| additional timeline | (input/output port) |
| t1 | sixth first bus subscriber 1615 |
| t2 | sixth second bus subscriber 1620 |
| t3 | sixth third bus subscriber 1625 |
| t4 | sixth seventh bus subscriber 1645 |
| t5 | sixth fifth bus subscriber 1635 |
| t6 | sixth eleventh bus subscriber 1665 |
| t7 | sixth fourth bus subscriber 1630 |
| t8 | sixth eighth bus subscriber 1650 |
| t9 | sixth ninth bus subscriber 1655 |
| t10 | sixth tenth bus subscriber 1660 |
| t11 | sixth ninth bus subscriber 1655 |
| t12 | sixth eighth bus subscriber 1650 |
| t13 | sixth fourth bus subscriber 1630 |
| t14 | sixth fifth bus subscriber 1635 |
| t15 | sixth sixth bus subscriber 1640 |
| t16 | sixth seventh bus subscriber 1645 |
| t17 | sixth third bus subscriber 1625 |
| t18 | sixth second bus subscriber 1620 |
| t19 | sixth first bus subscriber 1615 |

The timestamps t1 to t19 in Table 5 may each form the first and second timestamps T1, T2 of the bus subscribers of the automation network according to the sixth embodiment 1600, which are used to determine the set-up sequence of the sixth plurality of bus subscribers 1605 in accordance with the descriptions in FIGS. 6 and 16B. However, Table 5 does not include a third timestamp T3 for the receipt of the data packet via the third input/output port P2 of the sixth fifth bus subscriber 1635 and no fourth timestamp T4 for the receipt of the data packet via the fourth input/output port P3.

FIG. 7 shows a schematic depiction of a method 700 for controlling a plurality of bus subscribers in an automation network. The method 700 for controlling the plurality of bus subscribers may be applied to all of the described embodiments of the automation networks. A first step 705 of the method 700 for controlling the plurality of bus subscribers comprises providing a plurality of bus subscribers in an automation network. In a second step 710 of the method 700 for controlling the plurality of bus subscribers, a method for determining a set-up sequence of a plurality of bus subscribers of the automation network is carried out according to a first to fifth embodiment 100, 300, 400, 500, 600, and section 200 of the seventh step 135 of the method according to the first embodiment 100 is carried out according to the above features.

The method for determining the set-up sequence of the plurality of bus subscribers of the automation network according to the first to fifth embodiments 100, 300, 400, 500, 600, and the section 200 of the seventh step 135 of the method according to the first embodiment 100 form the basis for assigning the processing sequence to the set-up sequence of the bus subscribers. In a third step 715 of the method 700 for controlling the plurality of bus subscribers, the plurality of bus subscribers in the respective automation network are assigned to the bus subscribers in the automation network on the basis of the determined set-up sequence of the bus subscribers using the methods for determining the set-up sequence of the plurality of bus subscribers of the automation network according to the first to fifth embodiments 100, 300, 400, 500, 600, and the excerpt 200 of the seventh step 135 of the method according to the first embodiment 100.

The invention has been described in detail with the aid of preferred embodiments. Instead of the embodiments described, other embodiments are conceivable which may have further modifications or combinations of the features described. For this reason, the invention is not limited by the disclosed examples, since other variations may be derived from them by a person skilled in the art without leaving the protective scope of the invention.

TABLE 6
References 1-505

| | |
|---|---|
| 1-18 First to eighteenth place in set-up | 215 Third intermediate step of excerpt |
| sequence | from the method for determining bus |
| | subscribers |
| 21 First to eighteenth place in processing | 300 Method according to a second |
| sequence | embodiment |
| RX Receiving unit | 305 First step of method according to |
| | second embodiment |
| TX Transmitting unit | 310 Second step of method according to |
| | second embodiment |
| 100 Method according to a first | 315 Third step of method according to |
| embodiment | second embodiment |
| 105 First step of method according to first | 320 Fourth step of method according to |
| embodiment | second embodiment |
| 110 Second step of method according to | 325 Fifth step of method according to |
| first embodiment | second embodiment |
| 115 Third step of method according to first | 400 Method according to a third |
| embodiment | embodiment |
| 120 Fourth step of method according to | 405 First step of method according to |
| first embodiment | third embodiment |
| 123 Intermediate step of method according | 407 Intermediate step of method |
| to first embodiment | according to third embodiment |
| 125 Fifth step of method according to first | 410 Second step of method according to |
| embodiment | third embodiment |
| 130 Sixth step of method according to first | 415 Third step of third embodiment |
| embodiment | |
| 135 Seventh step of method according to | 420 Fourth step of method according to |
| first embodiment | third embodiment |
| 200 Excerpt from the method for | 425 Fifth step of method according to |
| determining a set-up sequence of bus | third embodiment |
| subscribers in an automation network | |
| 205 First intermediate step of excerpt from | 500 Method according to a fourth |
| the method for determining bus | embodiment |
| subscribers | |
| 210 Second intermediate step of excerpt | 505 First step of method according to |
| from the method for determining bus | fourth embodiment |
| subscribers | |

TABLE 7
References 507-P1

| | |
|---|---|
| 507 Intermediate step of method according | T2 Second timestamp |
| to fourth embodiment | |
| 510 Second step of method according to | T3 Third timestamp |
| fourth embodiment | |
| 515 Third step of method according to | T4 Fourth timestamp |
| fourth embodiment | |
| 520 Fourth step of method according to | t1 First timestamp of timeline |
| fourth embodiment | |
| 525 Fifth step of method according to | t2 Second timestamp of timeline |
| fourth embodiment | |
| 600 Method according to a fifth | t3 Third timestamp of timeline |
| embodiment | |
| 605 First step of method according to fifth | t4 Fourth timestamp of timeline |
| embodiment | |
| 607 Intermediate step of method according | t5 Fifth timestamp of timeline |
| to fifth embodiment | |
| 610 Second step of method according to | t6 Sixth timestamp of timeline |
| fifth embodiment | |
| 615 Third step of method according to fifth | t7 Seventh timestamp of timeline |
| embodiment | |
| 620 Fourth step of method according to | t8 Eighth timestamp of timeline |
| fifth embodiment | |
| 625 Fifth step of method according to fifth | t9 Ninth timestamp of timeline |
| embodiment | |
| 700 Method for controlling a plurality of | t10 Tenth timestamp of timeline |
| bus subscribers in an automation | |
| network | |
| 705 First step of method for controlling the | t11 Eleventh timestamp of timeline |
| plurality of bus subscribers | |
| 710 second step of method for controlling | t12 Twelfth timestamp of timeline |
| the plurality of bus subscribers | |
| 715 Third step of method for controlling | t13 Thirteenth timestamp of timeline |
| the plurality of bus subscribers | |
| 800 Bus subscriber according to a first | t14 Fourteenth timestamp of timeline |
| embodiment | |
| 805 First plurality of input/output ports | t15 Fifteenth timestamp of timeline |
| 820 Data line | t16 Sixteenth timestamp of timeline |
| 825 Forward path | t17 Seventeenth timestamp of timeline |
| 830 Return path | P0 First input/output port |
| T1 First timestamp | P1 Second input/output port |

TABLE 8
References P2-1403

| | |
|---|---|
| P2 Third input/output port | 1220 Second second bus subscriber |
| P3 Fourth input/output port | 1225 Second third bus subscriber |
| 900 Bus subscriber according to a second | 1230 Second fourth bus subscriber |
| embodiment | |
| 905 Second plurality of input/output ports | 1235 Second fifth bus subscriber |
| 935 Second forward data line | 1240 Second sixth bus subscriber |
| 940 Second return data line | 1245 Second seventh bus subscriber |
| 945 Processing unit | 1250 Second eighth bus subscriber |
| 950 Local clock | 1255 Second ninth bus subscriber |
| 955 Memory unit | 1300 Automation network according to a |
| | third embodiment |
| 1000 Bus subscriber according to a third | 1301 Third first module |
| embodiment | |
| 1005 Third plurality of input/output ports | 1302 Third second module |
| 1020 Third data line | 1303 Third third module |
| 1035 Third outgoing data line | 1305 Third plural of bus subscribers |
| 1040 Third return data line | 1310 Third control bus subscriber |
| 1100 Automation network according to a | 1315 Third first bus subscriber |
| first embodiment | |
| 1115 First first bus subscriber | 1320 Third second bus subscriber |
| 1120 First second bus subscriber | 1325 Third third bus subscriber |
| 1125 First third bus subscriber | 1330 Third fourth bus subscriber |
| 1130 First fourth bus subscriber | 1335 Third fifth bus subscriber |
| 1135 First fifth bus subscriber | 1340 Third sixth bus subscriber |
| 120 Automation network according to a | 1345 Third seventh bus subscriber |
| second embodiment | |
| 1201 Second robot arm | 1350 Third eighth bus subscriber |
| 1202 Second plurality of movable axes | 1355 Third ninth bus subscriber |
| 1205 Second plurality of bus subscribers | 1400 Automation network according to a |
| | fourth embodiment |
| 1210 Second control bus subscriber | 1402 Fourth plurality of movable axes |
| 1215 Second first bus subscriber | 1403 Fourth first robot arm |

TABLE 9
References 1404-1640

| | |
|---|---|
| 1404 Fourth second robot arm | 1506 Fifth second further data line |
| 1405 Fourth plurality of bus subscribers | 1510 Fifth control bus subscriber |
| 1410 Fourth control bus subscriber | 1515 Fifth first bus subscriber |
| 1415 Fourth first bus subscriber | 1520 Fifth second bus subscriber |
| 1420 Fourth second bus subscriber | 1525 Fifth third bus subscriber |
| 1425 Fourth third bus subscriber | 1530 Fifth fourth bus subscriber |
| 1430 Fourth fourth bus subscriber | 1535 Fifth fifth bus subscriber |
| 1435 Fourth fifth bus subscriber | 1540 Fifth sixth bus subscriber |
| 1440 Fourth sixth bus subscriber | 1545 Fifth seventh bus subscriber |
| 1445 Fourth seventh bus subscriber | 1550 Fifth eighth bus subscriber |
| 1450 Fourth eighth bus subscriber | 1555 Fifth ninth bus subscriber |
| 1455 Fourth ninth bus subscriber | 1560 Fifth tenth bus subscriber |
| 1460 Fourth tenth bus subscriber | 1565 First line |
| 1465 Fourth eleventh bus subscriber | 1570 Second line |
| 1470 Fourth twelfth bus subscriber | 1575 Third line |
| 1745 Fourth thirteenth bus subscriber | 1600 Automation network according to a |
| | sixth embodiment |
| 1480 Fourth fourteenth bus subscriber | 1601 Sixth first module |
| 1485 Fourth fifteenth bus subscriber | 1602 Sixth second module |
| 1490 Fourth sixteenth bus subscriber | 1603 Sixth third module |
| 1495 Fourth seventeenth bus subscriber | 1605 Sixth plural of bus subscribers |
| 1497 Fourth eighteenth bus subscriber | 1610 Sixth control bus subscriber |
| 1500 Automation network according to a | 1615 Sixth first bus subscriber |
| fifth embodiment | |
| 1501 Fifth first module | 1620 Sixth second bus subscriber |
| 1502 Fifth second module | 1625 Sixth third bus subscriber |
| 1503 Fifth third module | 1630 Sixth fourth bus subscriber |
| 1504 Fifth further data line | 1635 Sixth fifth bus subscriber |
| 1505 Fifth plurality of bus subscribers | 1640 Sixth sixth bus subscriber |

TABLE 10
References 1645-1720

| | |
|---|---|
| 1645 Sixth seventh bus subscriber | 1700 First timeline |
| 1650 Sixth eighth bus subscriber | 1705 Second timeline |
| 1655 Sixth ninth bus subscriber | 1710 First arrangement |
| 1660 Sixth tenth bus subscriber | 1720 Second arrangement |
| 1665 Sixth eleventh bus subscriber | |

What is claimed is:

1. A method for determining a bus subscriber arrangement in an automation network, wherein the automation network includes:
a control bus subscriber, and
a plurality of bus subscribers;
wherein the bus subscribers are connected to one another originating from the control bus subscriber via a data line network having at least one data line in a ring structure,
wherein each bus subscriber comprises at least a first and a second input/output port,
wherein the first input/output port and the second input/output port each comprise a receiving unit for receiving data packets and a transmitting unit for transmitting data packets,
wherein a data connection is provided between the receiving unit of the first input/output port and the transmitting unit of the second input/output port and between the receiving unit of the second input/output port and the transmitting unit of the first input/output port,
wherein the data line comprises a forward path and a return path for data packets output by the control bus subscribers,
wherein the forward path for the data packets leads from the control bus subscriber to the receiving unit of the one input/output port of the first bus subscriber, extends via the data connection between the receiving unit of the one input/output port and the transmitting unit of the other input/output port of the first bus subscriber, leads from the transmitting unit of the other input/output port of the first bus subscriber to the receiving unit of the one input/output port of the next bus subscriber, extends over the data connection between the receiving unit of the one input/output port and the transmitting unit of the other input/output port of the next bus subscriber, and further extends from the transmitting unit of the other input/output port of the next bus subscriber, if a further bus subscriber is connected to the other input/output port via the data line, up to the last bus subscriber, to the other input/output port of which no bus subscriber is connected via the data line,
wherein the data packets are routed from the forward path to the return path in the last bus subscriber, and
wherein the return path extends via the data connection between the receiving unit of the other input/output port of the last bus subscriber and the transmitting unit of the one input/output port of the last bus subscriber, from the transmitting unit of the one input/output port of the last bus subscriber to the receiving unit of the other input/output port of the preceding bus subscriber, extends via the data connection between the receiving unit of the other input/output port and the transmitting unit of the one input/output port of the preceding bus subscriber, and leads from the transmitting unit of the one input/output port of the preceding bus subscriber via further preceding bus subscribers to the control bus subscriber;
wherein the method comprises the following steps:
outputting a data packet via the control bus subscriber on the data line, wherein each bus subscriber records a forward timestamp upon receiving the data packet through the one input/output port on the forward path and a return timestamp upon receiving the data packet through the other input/output port on the return path,
correlating the recorded timestamps of each bus subscriber by forming a differential amount between the forward timestamp and the return timestamp of the bus subscriber is formed, wherein for the last bus subscriber, for which only a first timestamp is recorded, the second timestamp is set equal to the first timestamp, and
sorting the differential amounts from the largest value to the smallest value in order to determine the set-up sequence of the bus subscribers starting from the control bus subscriber as a set-up line of the bus subscribers.

2. The method according to claim 1, wherein:
each bus subscriber comprises a processing unit which is arranged in the data connection between the receiving unit of the first input/output port and the transmitting unit of the second input/output port in order to process data packets,
wherein, when calculating the difference between the forward timestamp and the return timestamp of the bus subscriber the first value is the timestamp assigned to the first input/output port and the second value is the timestamp assigned to the second input/output port of the bus subscriber, and
wherein the sign of the difference between the timestamp assigned to the first input/output port and the timestamp assigned to the second input/output port is evaluated in order to determine the processing sequence of the bus subscribers within the set-up sequence of the bus subscribers.

3. The method according to claim 2, wherein:
the processing units in the bus subscribers process the data packets in passing, and
wherein the EtherCAT transmission protocol is used as the communication protocol in the automation network.

4. The method according to claim 1, wherein:
the timestamps are recorded in the bus subscriber using a clock functionality of the bus subscriber, and
wherein the clock functionality provides the bus subscriber with a local system time.

5. The method according to claim 1, wherein:
at least one bus subscriber comprises a further second input/output port with a receiving unit for receiving data packets and a transmitting unit for transmitting data packets, wherein the further second input/output port is arranged in the data connection between the receiving unit of the second input/output port and the transmission unit of the first input/output port, wherein the receiving unit of the second input/output port is connected to the transmission unit of the further second input/output port and the receiving unit of the further second input/output port is connected to the transmitting unit of the first input/output port, wherein further bus subscribers are integrable into the ring structure originating from the further second input/output port via the data line network with a further data line,
wherein the forward path for the data packets leads from the transmitting unit of the further second input/output port to the receiving unit of the one input/output port of a further bus subscriber, extends via the data connection between the receiving unit of the one input/output port and the transmitting unit of the other input/output port of the further bus subscriber, leads from the transmitting unit of the other input/output port of the first bus subscriber to the receiving unit of the one input/output port of the next bus subscriber, extends over the data connection between the receiving unit of the one input/output port and the transmitting unit of the other input/output port of the next bus subscriber, and further originating from the transmitting unit of the other input/output port of the next bus subscriber, if a further bus subscriber is connected to the other input/output port via the data line, to the last bus subscriber, to the other input/output port of which no bus subscriber is connected via the data line,
wherein the data packets are routed from the forward path to the return path in the last bus subscriber,
wherein the return path extends via the data connection between the receiving unit of the other input/output port of the last bus subscriber and the transmitting unit of the one input/output port of the last bus subscriber, from the transmitting unit of the one input/output port of the last bus subscriber to the receiving unit of the other input/output port of the preceding bus subscriber, extends via the data connection between the receiving unit of the other input/output port and the transmitting unit of the one input/output port of the preceding bus subscriber, and from the transmitting unit of the one input/output port of the preceding bus subscriber via further preceding bus subscribers to the receiving unit of the further second input/output port, and
wherein the differential amounts formed between the forward timestamp and the return timestamp of the bus subscribers are sorted from the largest value to the smallest value in order to determine the set-up sequence of the bus subscribers starting from the control bus subscriber for which the bus subscribers connected to the further second input/output port are sorted separately from the other bus subscribers in order to determine a further set-up line at the bus subscribers originating from the further second input/output port.

6. The method according to claim 1, wherein the timestamps are storable in a memory unit of the bus subscriber, wherein the control bus subscriber is configured to read from the memory unit of the bus subscriber by sending a further data packet in order to obtain the recorded timestamps and determine the set-up sequence of the bus subscribers.

7. A method for determining a bus subscriber arrangement in an automation network, comprising the following steps:
outputting a data packet via a control bus subscriber on a data line, wherein each bus subscriber records a forward timestamp upon receiving the data packet through the one input/output port on the forward path and a return timestamp upon receiving the data packet through the other input/output port on the return path;
correlating the recorded timestamps of each bus subscriber by forming a differential amount between the forward timestamp and the return timestamp of the bus subscriber, wherein for the last bus subscriber, for which only a first timestamp is recorded, the second timestamp is set equal to the first timestamp; and
sorting the differences from the largest value to the smallest value in order to determine the set-up sequence of the bus subscribers starting from the control bus subscriber as a set-up line of the bus subscribers.

8. The method according to claim 7, wherein:
each bus subscriber comprises a processing unit which is arranged in the data connection between the receiving unit of the first input/output port and the transmitting unit of the second input/output port in order to process data packets,
wherein, when calculating the difference between the forward timestamp and the return timestamp of the bus subscriber the first value is the timestamp assigned to the first input/output port and the second value is the timestamp assigned to the second input/output port of the bus subscriber, and
wherein the sign of the difference between the timestamp assigned to the first input/output port and the timestamp assigned to the second input/output port is evaluated in order to determine the processing sequence of the bus subscribers within the set-up sequence of the bus subscribers.

9. The method according to claim 8, wherein:
the processing units in the bus subscribers process the data packets in passing, and
wherein the EtherCAT transmission protocol is used as the communication protocol in the automation network.

10. The method according to claim 7, wherein:
the timestamps are recorded in the bus subscriber using a clock functionality of the bus subscriber, and
wherein the clock functionality provides the bus subscriber with a local system time.

11. The method according to claim 7, wherein:
the timestamps are storable in a memory unit of the bus subscriber, and
wherein the control bus subscriber is configured to read from the memory unit of the bus subscriber by sending a further data packet in order to obtain the recorded timestamps and determine the set-up sequence of the bus subscribers.

12. An automation network including:
a control bus subscriber, and
a plurality of bus subscribers;
wherein the bus subscribers are connected to one another originating from the control bus subscriber via a data line network having at least one data line in a ring structure,
wherein each bus subscriber comprises at least a first and a second input/output port,
wherein the first input/output port and the second input/output port each comprise a receiving unit for receiving data packets and a transmitting unit for transmitting data packets,
wherein a data connection is provided between the receiving unit of the first input/output port and the transmitting unit of the second input/output port and between the receiving unit of the second input/output port and the transmitting unit of the first input/output port,
wherein the data line comprises a forward path and a return path for data packets output by the control bus subscribers, and
wherein the forward path for the data packets leads from the control bus subscriber to the receiving unit of the one input/output port of the first bus subscriber, extends via the data connection between the receiving unit of the one input/output port and the transmitting unit of the other input/output port of the first bus subscriber, leads from the transmitting unit of the other input/output port of the first bus subscriber to the receiving unit of the one input/output port of the next bus subscriber, extends over the data connection between the receiving unit of the one input/output port and the transmitting unit of the other input/output port of the next bus subscriber, and further extends from the transmitting unit of the other input/output port of the next bus subscriber, if a further bus subscriber is connected to the other input/output port via the data line, up to the last bus subscriber, to the other input/output port of which no bus subscriber is connected via the data line,
wherein the data packets are routed from the forward path to the return path in the last bus subscriber, and
wherein the return path extends via the data connection between the receiving unit of the other input/output port of the last bus subscriber and the transmitting unit of the one input/output port of the last bus subscriber, from the transmitting unit of the one input/output port of the last bus subscriber to the receiving unit of the other input/output port of the preceding bus subscriber, extends via the data connection between the receiving unit of the other input/output port and the transmitting unit of the one input/output port of the preceding bus subscriber, and leads from the transmitting unit of the one input/output port of the preceding bus subscriber via further preceding bus subscribers to the control bus subscriber;
wherein the control bus subscriber outputs a data packet via on the data line, wherein each bus subscriber records a forward timestamp upon receiving the data packet through the one input/output port on the forward path and a return timestamp upon receiving the data packet through the other input/output port on the return path,
wherein the control bus subscriber correlates the recorded timestamps of each bus subscriber by forming a differential amount between the forward timestamp and the return timestamp of the bus subscriber is formed, wherein for the last bus subscriber, for which only a first timestamp is recorded, the second timestamp is set equal to the first timestamp, and
wherein the control bus subscriber sorts the differential amounts from the largest value to the smallest value in order to determine the set-up sequence of the bus subscribers starting from the control bus subscriber as a set-up line of the bus subscribers.

13. The automation network according to claim 12, wherein:
each bus subscriber comprises a processing unit which is arranged in the data connection between the receiving unit of the first input/output port and the transmitting unit of the second input/output port in order to process data packets,
wherein, when calculating the difference between the forward timestamp and the return timestamp of the bus subscriber the first value is the timestamp assigned to the first input/output port and the second value is the timestamp assigned to the second input/output port of the bus subscriber, and
wherein the sign of the difference between the timestamp assigned to the first input/output port and the timestamp assigned to the second input/output port is evaluated in order to determine the processing sequence of the bus subscribers within the set-up sequence of the bus subscribers.

14. The automation network according to claim 13, wherein:
the processing units in the bus subscribers process the data packets in passing, and
wherein the EtherCAT transmission protocol is used as the communication protocol in the automation network.

15. The automation network according to claim 12, wherein:
the timestamps are recorded in the bus subscriber using a clock functionality of the bus subscriber, and wherein
the clock functionality provides the bus subscriber with a local system time.

16. The automation network according to claim 12, wherein:
at least one bus subscriber comprises a further second input/output port with a receiving unit for receiving data packets and a transmitting unit for transmitting data packets,
wherein the further second input/output port is arranged in the data connection between the receiving unit of the second input/output port and the transmission unit of the first input/output port,
wherein the receiving unit of the second input/output port is connected to the transmission unit of the further second input/output port and the receiving unit of the further second input/output port is connected to the transmitting unit of the first input/output port, wherein further bus subscribers are integrable into the ring structure originating from the further second input/output port via the data line network with a further data line,
wherein the forward path for the data packets leads from the transmitting unit of the further second input/output port to the receiving unit of the one input/output port of a further bus subscriber, extends via the data connection between the receiving unit of the one input/output port and the transmitting unit of the other input/output port of the further bus subscriber, leads from the transmitting unit of the other input/output port of the first bus subscriber to the receiving unit of the one input/output port of the next bus subscriber, extends over the data connection between the receiving unit of the one input/output port and the transmitting unit of the other input/output port of the next bus subscriber, and further originating from the transmitting unit of the other input/output port of the next bus subscriber, if a further bus subscriber is connected to the other input/output port via the data line, to the last bus subscriber, to the other input/output port of which no bus subscriber is connected via the data line,
wherein the data packets are routed from the forward path to the return path in the last bus subscriber,
wherein the return path extends via the data connection between the receiving unit of the other input/output port of the last bus subscriber and the transmitting unit of the one input/output port of the last bus subscriber, from the transmitting unit of the one input/output port of the last bus subscriber to the receiving unit of the other input/output port of the preceding bus subscriber, extends via the data connection between the receiving unit of the other input/output port and the transmitting unit of the one input/output port of the preceding bus subscriber, and from the transmitting unit of the one input/output port of the preceding bus subscriber via further preceding bus subscribers to the receiving unit of the further second input/output port, and
wherein the differential amounts formed between the forward timestamp and the return timestamp of the bus subscribers are sorted from the largest value to the smallest value in order to determine the set-up sequence of the bus subscribers starting from the control bus subscriber for which the bus subscribers connected to the further second input/output port are sorted separately from the other bus subscribers in order to determine a further set-up line at the bus subscribers originating from the further second input/output port.

17. The automation network according to claim 12, wherein:
the timestamps are storable in a memory unit of the bus subscriber, and
wherein the control bus subscriber is configured to read from the memory unit of the bus subscriber by sending a further data packet in order to obtain the recorded timestamps and determine the set-up sequence of the bus subscribers.
